(19) United States
(12) Patent Application Publication
(10) Pub. No.: US 2026/0162343 A1
(43) Pub. Date: Jun. 11, 2026

(54) ANIMATION GENERATION METHOD AND APPARATUS, DEVICE, AND STORAGE MEDIUM

(71) Applicant: Tencent Technology (Shenzhen) Company Limited, Shenzhen (CN)

(72) Inventors: Li Huang, Shenzhen (CN); Fan Yang, Shenzhen (CN); Chun Yuan, Shenzhen (CN); Yu Ju Chen, Shenzhen (CN); Ming Gao, Shenzhen (CN); Chendi Wei, Shenzhen (CN)

(21) Appl. No.: 19/180,504

(22) Filed: Apr. 16, 2025

Related U.S. Application Data
(63) Continuation of application No. PCT/CN2024/078492, filed on Feb. 26, 2024.

(30) Foreign Application Priority Data
Apr. 26, 2023 (CN) 2023104788963

(51) Int. Cl. G06T 13/40

(52) U.S. Cl. CPC G06T 13/40; G06T 2210/21

(57) ABSTRACT

An animation method includes: determining a plurality of polylines corresponding to a plurality of strip-shaped three-dimensional models, each strip-shaped three-dimensional model being bound to a specified three-dimensional model; determining, for a target polyline, in response to the specified three-dimensional model moving at an i^{th} moment, force data respectively corresponding to a plurality of special effect particles on the target polyline at the i^{th} moment; calculating, based on the force data, a speed change amount of each special effect particle from the i^{th} moment to an (i+1)^{th} moment; and calculating, based on movement speeds of the plurality of special effect particles on the plurality of polylines at the i^{th} moment and speed change amounts of the plurality of special effect particles on the plurality of polylines from the i^{th} moment to the (i+1)^{th} moment, movement trajectories respectively corresponding to the plurality of special effect particles.

### CROSS-REFERENCE TO RELATED APPLICATIONS

This application is a continuation application of PCT Patent Application No. PCT/CN2024/078492, filed on Feb. 26, 2024, which claims priority to Chinese Patent Application No. 2023104788963, filed on Apr. 26, 2023, each entitled “ANIMATION GENERATION METHOD AND APPARATUS, DEVICE, STORAGE MEDIUM, AND PROGRAM PRODUCT,” and each of which is incorporated herein by reference in its entirety.

### FIELD

Embodiments of the present disclosure relate to the field of computer technologies, and in particular, to animation generation technologies.

### BACKGROUND

Computer graphics technology is a branch in the application computer science, and is widely applied to the game field, the modeling field, and the like. In recent years, with great popularity of virtual digital objects in the modeling field, high-quality virtual digital objects attract more and more attention, and high-fidelity three-dimensional (3D) hair can significantly improve the sense of reality of virtual digital objects.

Generally, a simulation method based on a point-line model is adopted, where hair is modeled into a plurality of line segments with a finite length, each line segment being formed by a specific quantity of particles and connection lines connecting adjacent particles, and the movement status of the hair is calculated by comprehensively analyzing movement statuses of the plurality of particles.

However, in the analysis method, movement trajectories of a large quantity of hairs need to be calculated by comprehensively considering movement statuses of a plurality of hairs. Both collision between hairs and collision statuses of a plurality of particles on each hair need to be considered, resulting in a large amount of data to be analyzed and low analysis efficiency. The method cannot be well applied to an animation generation scenario requiring high real-time performance.

### SUMMARY

Embodiments of the present disclosure provide an animation generation method and apparatus, a device, a medium, and a program product, to improve calculation and analysis efficiency while ensuring trajectory calculation accuracy, and generate an animation of a strip-shaped three-dimensional model moving with a specified three-dimensional model more instantaneously and efficiently. Solutions are as follows:

In one aspect, an animation generation method is provided, and is performed by a computer device (e.g., a computing device). The method includes:
determining polylines respectively corresponding to a plurality of strip-shaped three-dimensional models, the polyline including a plurality of special effect particles, and the strip-shaped three-dimensional model being bound to a specified three-dimensional model;
for a target polyline in the plurality of polylines, determining, in response to that the specified three-dimensional model moves at an i^{th} moment, force data respectively corresponding to the plurality of special effect particles on the target polyline at the i^{th} moment based on a movement speed and a movement direction of the specified three-dimensional model, the force data being configured for indicating a force status of the special effect particle on the target polyline when moving with the specified three-dimensional model, and i being a positive integer;
calculating a speed change amount of each special effect particle on the target polyline from the i^{th} moment to an (i+1)^{th} moment based on the force data corresponding to the special effect particle; and
calculating movement trajectories respectively corresponding to the special effect particles on the plurality of polylines based on movement speeds of the special effect particles on the plurality of polylines at the i^{th} moment and speed change amounts of the special effect particles on the plurality of polylines from the i^{th} moment to the (i+1)^{th} moment, and generating, based on the movement trajectories, an animation of the plurality of strip-shaped three-dimensional models moving with the specified three-dimensional model.

In another aspect, an animation generation apparatus is provided. The apparatus includes:
a polyline determining module, configured to determine polylines respectively corresponding to a plurality of strip-shaped three-dimensional models, the polyline including a plurality of special effect particles, and the strip-shaped three-dimensional model being bound to a specified three-dimensional model;
a force determining module, configured to determine, for a target polyline in the plurality of polylines, in response to that the specified three-dimensional model moves at an i^{th} moment, force data respectively corresponding to the plurality of special effect particles on the target polyline at the i^{th} moment based on a movement speed and a movement direction of the specified three-dimensional model, the force data being configured for indicating a force status of the special effect particle on the target polyline when moving with the specified three-dimensional model, and i being a positive integer;
a speed determining module, configured to calculate a speed change amount of each special effect particle on the target polyline from the i^{th} moment to an (i+1)^{th} moment based on the force data corresponding to the special effect particle; and
a trajectory calculation module, configured to calculate movement trajectories respectively corresponding to the special effect particles on the plurality of polylines based on movement speeds of the special effect particles on the plurality of polylines at the i^{th} moment and speed change amounts of the special effect particles on the plurality of polylines from the i^{th} moment to the (i+1)^{th} moment, and generate, based on the movement trajectories, an animation of the plurality of strip-shaped three-dimensional models moving with the specified three-dimensional model.

In another aspect, a computer device (e.g., a computing device) is provided, including a processor and a memory, the memory having at least one instruction, at least one segment of program, a code set, or an instruction set stored therein, the at least one instruction, the at least one segment of program, the code set, or the instruction set being loaded and executed by the processor to implement the animation generation method according to any one of the foregoing embodiments of the present disclosure.

In another aspect, a computer-readable storage medium is provided, the storage medium having at least one instruction, at least one segment of program, a code set, or an instruction set stored therein, the at least one instruction, the at least one segment of program, the code set, or the instruction set being loaded and executed by a processor to implement the animation generation method according to any one of the foregoing embodiments of the present disclosure.

In another aspect, a computer program product or a computer program is provided. The computer program product or the computer program includes computer instructions. The computer instructions are stored in a computer-readable storage medium. A processor of a computer device reads the computer instructions from the computer-readable storage medium. The processor executes the computer instructions, to cause the computer device to perform the animation generation method according to any one of the foregoing embodiments.

The solutions provided in the embodiments of the present disclosure have at least the following beneficial effects.

In the embodiments of the present disclosure, an example in which target polylines in polylines respectively corresponding to a plurality of strip-shaped three-dimensional models are analyzed is used. Based on a movement speed and a movement direction of a specified three-dimensional model at an i^{th} moment, force data respectively corresponding to a plurality of special effect particles on the target polyline is determined, to calculate speed change amounts of the special effect particles, and further, movement trajectories respectively corresponding to the special effect particles on the plurality of polylines are calculated based on the movement speeds and the speed change amounts of the special effect particles on the plurality of polylines. In this way, a problem of poor analysis efficiency caused by directly performing comprehensive analysis on a plurality of polylines is avoided. In the present disclosure, the plurality of polylines are first respectively analyzed, the speed change amounts respectively corresponding to the plurality of special effect particles on the polylines are determined, and the plurality of polylines are further comprehensively analyzed based on analyzing the plurality of polylines respectively. In this way, calculation and analysis efficiency can be improved, an animation of a strip-shaped three-dimensional model moving with a specified three-dimensional model can be generated more instantaneously and efficiently, and timeliness of animation generation can be improved, so that the animation generation method for a strip-shaped three-dimensional model can be applied to a wider range of scenarios.

### BRIEF DESCRIPTION OF THE DISCLOSURE

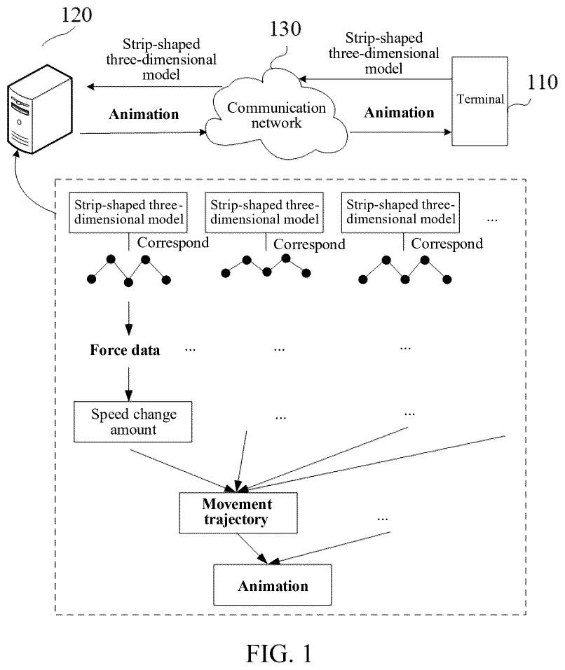

FIG. 1 is a schematic diagram of an implementation environment according to an exemplary embodiment of the present disclosure.

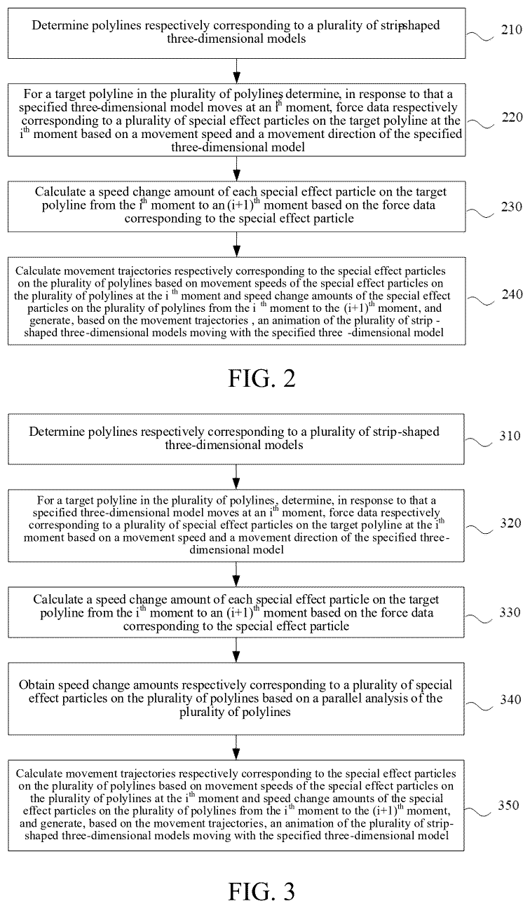

FIG. 2 is a flowchart of an animation generation method according to an exemplary embodiment of the present disclosure.

FIG. 3 is a flowchart of an animation generation method according to another exemplary embodiment of the present disclosure.

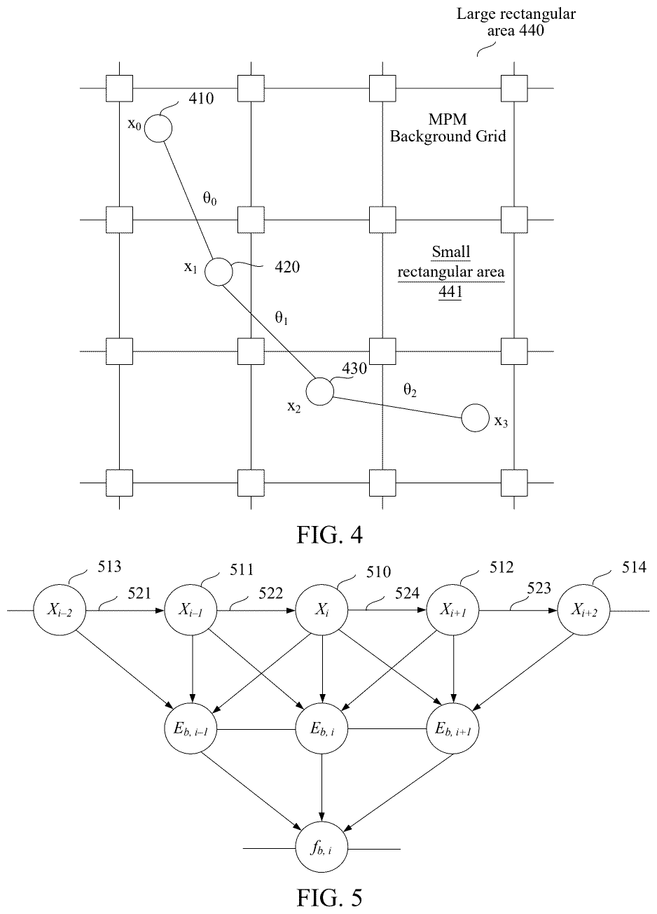

FIG. 4 is a schematic diagram of polylines corresponding to a strip-shaped three-dimensional model according to an exemplary embodiment of the present disclosure.

FIG. 5 is a schematic diagram of calculating force data of special effect particles according to an exemplary embodiment of the present disclosure.

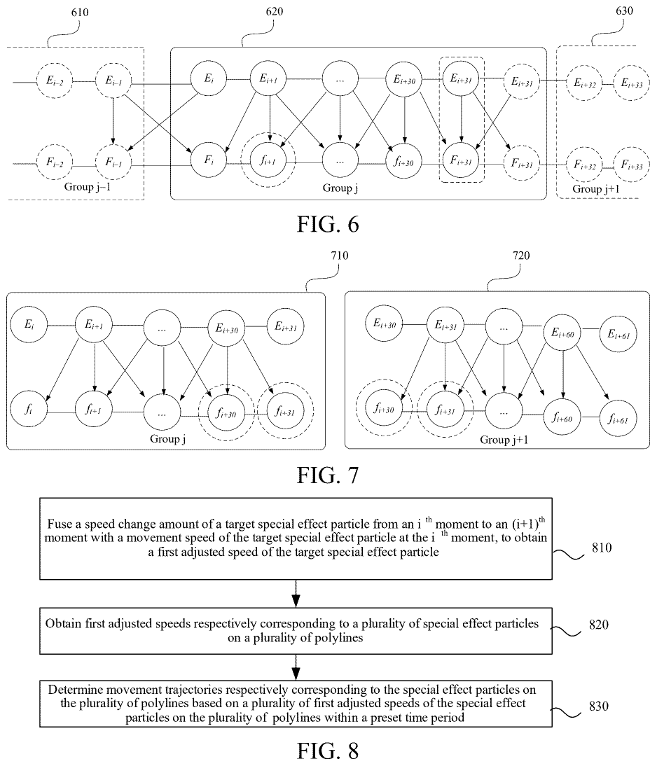

FIG. 6 is a schematic diagram of directly grouping special effect particles according to an exemplary embodiment of the present disclosure.

FIG. 7 is a schematic diagram of grouping special effect particles in an overlapping grouping manner according to an exemplary embodiment of the present disclosure.

FIG. 8 is a flowchart of an animation generation method according to another exemplary embodiment of the present disclosure.

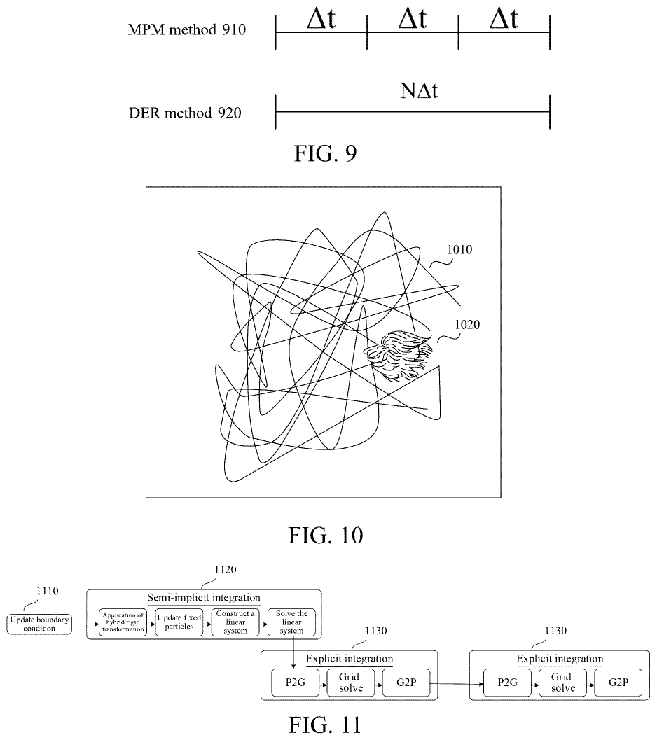

FIG. 9 is a schematic diagram of comparison between step lengths of time steps according to an exemplary embodiment of the present disclosure.

FIG. 10 is a schematic diagram of a specified three-dimensional model moving along a trajectory route according to an exemplary embodiment of the present disclosure.

FIG. 11 is a flowchart of an animation generation method according to another exemplary embodiment of the present disclosure.

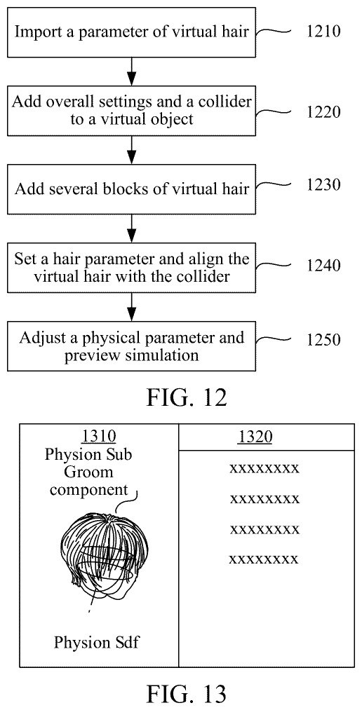

FIG. 12 is a flowchart of configuring a game engine according to an exemplary embodiment of the present disclosure.

FIG. 13 is a diagram of a setting interface of virtual hair parameters according to an exemplary embodiment of the present disclosure.

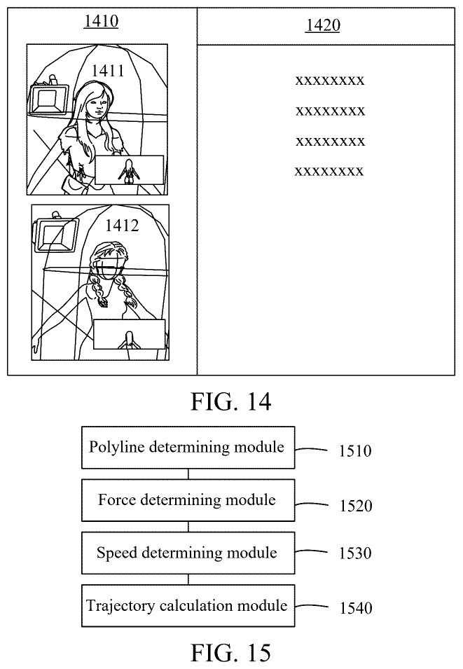

FIG. 14 is a schematic diagram of an interface for previewing an animation of virtual hair moving with a virtual head according to an exemplary embodiment of the present disclosure.

FIG. 15 is a structural block diagram of an animation generation apparatus according to an exemplary embodiment of the present disclosure.

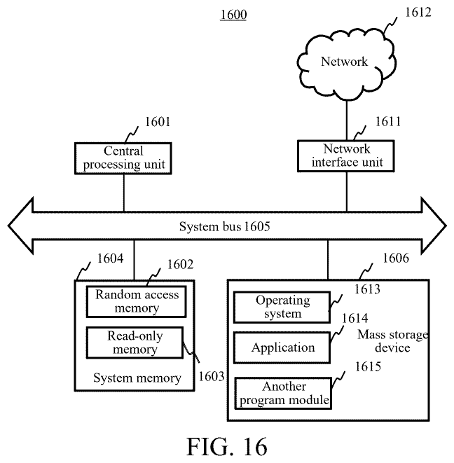

FIG. 16 is a structural block diagram of a server according to an exemplary embodiment of the present disclosure.

### DETAILED DESCRIPTION

The following further describes the implementations of the present disclosure in detail with reference to the accompanying drawings.

First, terms described in the embodiments of the present disclosure are briefly introduced.

A graphics processing unit (GPU), also referred to as a display core, a vision processor, a display chip, or a graphics chip, is a microprocessor performing drawing and computation specifically in a personal computer, a workstation, a game console, and some mobile devices (such as a tablet computer and a smartphone). The GPU has hundreds or thousands of cores, and can run a large quantity of computation in parallel after optimization. The GPU is known for 3D rendering in games, and are especially useful for running analysis, deep learning, and machine learning algorithms. Some computation run in the GPU are 10 times to 100 times faster than the same computation run in a conventional central processing unit (CPU).

Generally, a simulation method based on a point-line model is adopted, hair is modeled into a plurality of line segments with a finite length, and each line segment is formed by a specific quantity of particles and a connection line connecting adjacent particles. A movement status of the hair is calculated by comprehensively analyzing movement statuses of the plurality of particles. However, in the foregoing analysis method, movement trajectories of a large quantity of hairs need to be calculated by comprehensively considering movement statuses of a plurality of hair. Both collision between hairs and collision statuses of a plurality of particles on a hair need to be considered, an analysis data volume is large, and analysis efficiency is low. The method cannot be well applied to an animation generation scenario requiring high real-time performance.

In the embodiments of the present disclosure, polylines corresponding to a plurality of strip-shaped three-dimensional model bound to a specified three-dimensional model, where the polyline includes a plurality of special effect particles; for a target polyline in the plurality of polylines, in response to that the specified three-dimensional model moves at an i^{th} moment, force data respectively corresponding to the plurality of special effect particles on the target polyline at an i^{th} moment is determined based on a movement speed and a movement direction of the specified three-dimensional model; based on the force data, a speed change amount of the special effect particle from the i^{th} moment to an (i+1)^{th} moment, to obtain speed change amounts respectively corresponding to the plurality of special effect particles on the target polyline; and movement trajectories respectively corresponding to the special effect particles on the plurality of polylines are calculated based on movement speeds of the special effect particles at the i^{th} moment and speed change amounts of the special effect particles from the i^{th} moment to the (i+1)^{th} moment, and based on the movement trajectories, an animation of the plurality of strip-shaped three-dimensional models moving with the specified three-dimensional model is generated. Based on a process of respectively analyzing the plurality of polylines, a problem of poor analysis efficiency caused by directly performing comprehensive analysis on a plurality of polylines is avoided. The plurality of polylines are first respectively analyzed, the speed change amounts respectively corresponding to the plurality of special effect particles on the polylines are determined, and the plurality of polylines are further comprehensively analyzed based on analyzing the plurality of polylines respectively. In this way, calculation and analysis efficiency can be improved, an animation of a strip-shaped three-dimensional model moving with a specified three-dimensional model can be generated more instantaneously and efficiently, and timeliness of animation generation can be improved.

Based on the foregoing animation generation method, an animation effect a strip-shaped three-dimensional model moving with a specified three-dimensional model can be generated, and the method is applicable to various animation generation fields such as game image generation and scene construction. For example, an animation effect of hair of a virtual object moving with movement of the head of the virtual object is generated, an animation effect of a grassland moving with vibration of a ground in a virtual environment is generated, and an animation effect hair of a virtual animal moving with movement of the virtual animal is generated. The foregoing animation generation field and animation generation scenario are merely an example for illustration, and are not limited in the present disclosure.

Information (including but not limited to user equipment information, user personal information, and the like), data (including but not limited to data for analysis, data for storage, data for display, and the like), and signals involved in the present disclosure are all authorized by users or fully authorized by all parties, and collection, use, and processing of relevant data need to comply with relevant laws, regulations, and standards of relevant regions. For example, data content such as a plurality of strip-shaped three-dimensional model and a force value involved in the present disclosure are obtained under full authorization.

In addition, an implementation environment involved in the embodiments of the present disclosure is described. The animation generation method provided in the embodiments of the present disclosure may be performed by a computer device (e.g., a computing device), and may be performed by a terminal independently, may be performed by a server independently, or may be implemented through data exchange between a terminal and a server, which is not limited in the embodiments of the present disclosure. In some embodiments, an example in which a terminal and a server interact to perform the animation generation method is used for description.

For example, referring to FIG. 1, a terminal 110 and a server 120 are involved in the implementation environment. The terminal 110 and the server 120 are connected through a communication network 130.

In some embodiments, the terminal 110 has a virtual object control function, and the virtual object control function is configured for controlling a virtual object to move in a virtual environment. For example, a game application is installed on the terminal 110, and a player operating the terminal 110 may control, by operating the game application, a virtual object in the game to move in a virtual scene. For example, the player controls the virtual object to run, jump, turn the head of the virtual object, and the like in a virtual environment.

In some embodiments, when the player controls the virtual object to move, a position of the head of the virtual object changes relative to the virtual environment, and virtual hair bound to the virtual head also correspondingly moves. The virtual head is a specified three-dimensional model, and the virtual hair is a strip-shaped three-dimensional model bound to the specified three-dimensional model.

In some embodiments, the terminal 110 sends a plurality of strip-shaped three-dimensional models to the server 120 through the communication network 130, so that the server 120 obtains the plurality of strip-shaped three-dimensional models, and determines polylines respectively corresponding to the plurality of strip-shaped three-dimensional models. In other words, the server 120 obtains polylines corresponding to a plurality of virtual hairs. The polyline includes a plurality of special effect particles. For example, a plurality of special effect particles included in each polyline are particles divided for ease of analyzing the virtual hair.

In some embodiments, the terminal 110 may further send control data configured for representing a control operation triggered by the player on the virtual object to the server 120 through the communication network 130. The control data includes movement data such as a movement speed and a movement direction of the virtual head.

For example, for any target polyline in the plurality of polylines, if the control data received by the server 120 instructs the specified three-dimensional model to move at an i^{th} moment, force values respectively corresponding to a plurality of special effect particles on the target polyline at the i^{th} moment are determined based on a movement speed and a movement direction of the specified three-dimensional model. In other words, the server 120 determines, based on the movement speed and the movement direction of the virtual head, the force values respectively corresponding to the plurality of special effect particles on the target virtual hair at the i^{th} moment. The force value is configured for representing a force status of the special effect particle on the target polyline when moving with the specified three-dimensional model, and i is a positive integer.

In some embodiments, after determining the force values respectively corresponding to the plurality of special effect particles on the target polyline, the server 120 calculates, based on the force values, speed change amounts of the plurality of special effect particles from the i^{th} moment to an (i+1)^{th} moment, to obtain the speed change amounts respectively corresponding to the plurality of special effect particles on the target polyline.

In some embodiments, the server 120 calculates movement trajectories respectively corresponding to the plurality of special effect particles based on the movement speeds of the special effect particles on the plurality of polylines and the speed change amounts of the special effect particles at the i^{th} moment. For example, the server 120 uses a plurality of polylines as target polylines in a manner of analyzing the target polyline, to determine speed change amounts respectively corresponding to a plurality of special effect particles on the plurality of polylines, and further, based on the movement speeds of the special effect particles on the plurality of polylines and the speed change amounts of the special effect particles at the i^{th} moment, more efficiently and accurately calculate the movement trajectories respectively corresponding to the plurality of special effect particles after respectively analyzing the polylines and analyzing the polylines as a whole.

In some embodiments, the server 120 generates, based on the calculated movement trajectories respectively corresponding to the plurality of special effect particles, an animation of a strip-shaped three-dimensional model moving with the specified three-dimensional model, and sends the animation to the terminal 110 through the communication network 130. The terminal 110 renders and displays, on a screen, the animation of the strip-shaped three-dimensional model moving with the specified three-dimensional model, to display the animation of the strip-shaped three-dimensional model moving with the specified three-dimensional model more timely.

The terminal includes, but is not limited to, a mobile terminal such as a mobile phone, a tablet computer, a portable laptop notebook computer, an intelligent voice interaction device, a smart home appliance, or an in-vehicle terminal, or may be a desktop computer or the like. The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In some embodiments, the server may alternatively be implemented as a node in a blockchain system.

With reference to the brief introduction of terms and application scenarios, the animation generation method provided in the present disclosure is described. The method is described by using an example in which the method is performed by a server. As shown in FIG. 2, the method includes the following operation 210 to operation 240.

Operation 210: Determine polylines respectively corresponding to a plurality of strip-shaped three-dimensional models.

For example, the strip-shaped three-dimensional model is configured for instructing to present a strip-shaped or bar-shaped three-dimensional model, and implementation of the strip-shaped three-dimensional model may be, for example, virtual hair, virtual flowers and grass, and virtual fur.

In some embodiments, based on factors such as a length and a thickness of the strip-shaped three-dimensional model, polylines respectively corresponding to the plurality of strip-shaped three-dimensional models are obtained.

In some embodiments, a player operates a virtual object on a terminal, so that virtual hair of the virtual object moves with movement of the head of the virtual object, and the virtual hair is implemented as the foregoing strip-shaped three-dimensional model; or a virtual scene developer simulates a virtual grassland in a virtual environment, and uses the virtual grassland as the foregoing strip-shaped three-dimensional model, or the like.

For example, the terminal sends the plurality of strip-shaped three-dimensional models to the server, and the server obtains the polylines respectively corresponding to the plurality of strip-shaped three-dimensional models; or the server generates a plurality of strip-shaped three-dimensional models based on model development, and determines, when analyzing the strip-shaped three-dimensional models, polylines respectively corresponding to the plurality of strip-shaped three-dimensional models, or the like.

Each polyline includes a plurality of special effect particles.

For example, a plurality of special effect particles on a polyline are connected by particle connection edges. When the polyline includes n special effect particles, n−1 particle connection edges are included, to connect the n special effect particles.

In some embodiments, the special effect particle is a particle located on a polyline and configured for adjusting a presentation form of the polyline. For example, the special effect particles can adjust a bending degree of a polyline, such as adjusting an angle between two edges connecting the special effect particles, to adjust a completeness degree of the polyline; or the special effect particle can adjust a twisting degree of a polyline, such as adjusting a twisting degree of two edges connecting the special effect particles in space.

The strip-shaped three-dimensional model is bound to the specified three-dimensional model.

For example, the strip-shaped three-dimensional model may be a model directly bound to a specified three-dimensional model, that is, a model visually having a direct connection relationship with the specified three-dimensional model. In some embodiments, when the strip-shaped three-dimensional model is implemented as virtual hair, the specified three-dimensional model may be implemented as a virtual head bound to the virtual hair; or when the strip-shaped three-dimensional model is implemented as a virtual grassland, the specified three-dimensional model may be implemented as a virtual ground bound to the virtual grassland; or when the strip-shaped three-dimensional model is implemented as virtual fur, the specified three-dimensional model may be implemented as a virtual animal bound to the virtual hair (for example, virtual dog hair bound to a virtual dog). Certainly, in an actual application, the strip-shaped three-dimensional model may alternatively be a model indirectly bound to the specified three-dimensional model, that is, a model that does not have a direct connection relationship with the specified three-dimensional model visually. This is not limited in the embodiments of the present disclosure.

Operation 220: For a target polyline in the plurality of polylines, determine, in response to that the specified three-dimensional model moves at an i^{th} moment, force data respectively corresponding to the plurality of special effect particles on the target polyline at the i^{th} moment based on a movement speed and a movement direction of the specified three-dimensional model.

For example, the target polyline is any polyline in the polylines respectively corresponding to the plurality of strip-shaped three-dimensional models. When the plurality of polylines are analyzed, the plurality of polylines are respectively analyzed. In the embodiments of the present disclosure, an example in which the target polyline in the plurality of polylines is analyzed is used for description below.

The i^{th} moment is any moment. For example, the i^{th} moment may be a moment in a game process, or the i^{th} moment may be a moment in a scene construction process.

In some embodiments, a movement status of the specified three-dimensional model is detected in a real-time detection manner or a periodic detection manner. When it is detected that the specified three-dimensional model moves at the i^{th} moment, the plurality of special effect particles on the target polyline are analyzed. For example, the virtual head is the specified three-dimensional model, and a movement status of the virtual head of the virtual object is detected in real time in a game process. When it is detected that the virtual head moves in a virtual scene at an i^{th} moment, a plurality of special effect particles on a selected target virtual hair are analyzed.

In some embodiments, the force data respectively corresponding to the plurality of special effect particles on the target polyline at the i^{th} moment is determined based on the movement speed and the movement direction of the specified three-dimensional model.

For example, when the specified three-dimensional model bound to the plurality of strip-shaped three-dimensional models moves, the plurality of strip-shaped three-dimensional models also move correspondingly, and the movement process is associated with the movement of the specified three-dimensional model.

Based on the movement of the specified three-dimensional model, the movement speed and the movement direction of the specified three-dimensional model are determined, to determine the force data respectively corresponding to the plurality of special effect particles on the target polyline corresponding to the selected strip-shaped three-dimensional model.

The force data is configured for representing a force status of the special effect particle on the target polyline when moving with the specified three-dimensional model, and may represent a force magnitude and a force direction, where i is a positive integer.

For example, when the movement speed of the specified three-dimensional model is fast, a force of the plurality of special effect particles on the target polyline is high; and when the movement direction of the specified three-dimensional model transforms quickly, the force of the plurality of special effect particles on the target polyline is high.

In some embodiments, the force data may be implemented as at least one of a stretching force, a bending force, or a twisting force.

The stretching force is defined on a particle connection edge connecting special effect particles, and is configured for representing stretching between two special effect particles connected by the particle connection edge. For example, a special effect particle A and a special effect particle B are connected by a particle connection edge 1, when a movement speed of the specified three-dimensional model is high, a movement speed of the special effect particle A approaching the specified three-dimensional model is high, and a movement speed of the special effect particle B keeping away from the specified three-dimensional model is low, so that a stretching force is generated on the particle connection edge 1.

The bending force is defined on a special effect particle, and is configured for representing bending caused by a change of an angle between particle connection edges on two sides of the special effect particle. For example, a particle connection edge 1 and a particle connection edge 2 are connected by a special effect particle A, and when the specified three-dimensional model changes a direction, a bending force is determined based on a change of an angle between the particle connection edge 1 and the particle connection edge 2.

The twisting force is defined on a special effect particle, and is configured for representing twisting caused by a twisting change of particle connection edges on two sides of the special effect particle in space. For example, a particle connection edge 1 and a particle connection edge 2 are connected by a special effect particle A, and when the specified three-dimensional model changes a direction, a twisting force is determined based on twisting of the particle connection edge 1 and the particle connection edge 2 in space.

In some embodiments, a resultant force of a stretching force, a bending force, and a twisting force is used as force data corresponding to a special effect particle, to determine the force data respectively corresponding to the plurality of special effect particles on the target polyline.

Operation 230: Calculate a speed change amount of each special effect particle on the target polyline from the i^{th} moment to an (i+1)^{th} moment based on the force data corresponding to the special effect particle.

For example, after the force data respectively corresponding to the plurality of special effect particles is obtained, particle masses respectively corresponding to the plurality of special effect particles are determined.

In some embodiments, the particle mass is a preset particle parameter. For example, it is set that the plurality of special effect particles all have the same particle mass; or it is set that a part of special effect particles has a particle mass, and another part of special effect particles has another particle mass.

In some embodiments, based on the force data of the special effect particle and the particle mass corresponding to the special effect particle, an acceleration corresponding to the special effect particle is determined according to Newton's second law.

In some embodiments, a time difference is determined based on the i^{th} moment to the (i+1)^{th} moment, and then a speed change amount of the special effect particle from the i^{th} moment to the (i+1)^{th} moment is determined based on the time difference and the acceleration.

In some embodiments, a plurality of special effect particles on the target polyline are respectively analyzed based on the foregoing process, to determine the speed change amounts respectively corresponding to the plurality of special effect particles.

Operation 240: Calculate movement trajectories respectively corresponding to the special effect particles on the plurality of polylines based on movement speeds of the special effect particles on the plurality of polylines at the i^{th} moment and speed change amounts of the special effect particles on the plurality of polylines from the i^{th} moment to the (i+1)^{th} moment, and generate, based on the movement trajectories, an animation of the plurality of strip-shaped three-dimensional models moving with the specified three-dimensional model.

In some embodiments, in addition to determining the speed change amounts respectively corresponding to the plurality of special effect particles on the target polyline, speed change amounts of special effect particles on other polylines in the plurality of polylines are determined according to implementations of operation 220 and operation 230.

In some embodiments, the movement speeds of the special effect particles on the plurality of polylines at the i^{th} moment are determined. The movement speeds are configured for representing initial speeds of the special effect particles at the i^{th} moment. In addition, each polyline is respectively analyzed, to obtain a speed change amount of a special effect particle on each polyline.

In some embodiments, for each special effect particle, after the movement speed of the special effect particle at the i^{th} moment and the speed change amount from the i^{th} moment to the (i+1)^{th} moment are determined, a sum of the movement speed and the speed change amount is calculated, to obtain an adjusted speed respectively corresponding to each special effect particle, that is, to obtain first adjusted speeds corresponding to the plurality of special effect particles on the plurality of polylines.

In some embodiments, the movement trajectories respectively corresponding to the plurality of special effect particles are determined based on the first adjusted speeds.

For example, a speed change amount of a special effect particle is determined based on a movement status of a polyline to which the special effect particle belongs. Further, a first adjusted speed is obtained based on a speed change amount and the movement speed. The first adjusted speed can directly show a movement trajectory of a strip-shaped three-dimensional model corresponding to a polyline moving with a specified three-dimensional model.

In some embodiments, after the first adjusted speed of each special effect particle is obtained, comprehensive analysis is performed on the plurality of special effect particles on the plurality of polylines, collision statuses between the plurality of special effect particles are calculated, and the first adjusted speeds respectively corresponding to the plurality of special effect particles are adjusted based on the collision statuses, to obtain second adjusted speeds.

In some embodiments, the movement trajectories respectively corresponding to the plurality of special effect particles are determined based on the second adjusted speeds.

For example, after the first adjusted speed is obtained based on the speed change amount and the movement speed, considering that collisions may also exist between a plurality of polylines to cause a plurality of special effect particles on the plurality of polylines to collide, collision detection is performed on the plurality of special effect particles on the plurality of polylines, to adjust the first adjusted speed determined based on the polyline, so that the second adjusted speed obtained after adjustment can present a force relationship between a plurality of special effect particles on the same polyline, and can present a random collision relationship between the plurality of special effect particles on the plurality of polylines, to improve systematicness of the special effect particle analysis through a sequential analysis process. In this way, a movement trajectory of the strip-shaped three-dimensional model corresponding to the polyline moving with the specified three-dimensional model is obtained.

In an exemplary embodiment, based on movement trajectories respectively corresponding to the plurality of special effect particles, a movement area of the polyline including the special effect particle is adjusted.

For example, the plurality of special effect particles includes a special effect particle A, a special effect particle B, a special effect particle C, and a special effect particle D. The special effect particle A and the special effect particle B are special effect particles on a polyline 1, and the special effect particle C and the special effect particle D are special effect particles on a polyline 2. Based on movement trajectories respectively corresponding to the special effect particle A and the special effect particle B, a movement area of the polyline 1 including the special effect particle A and the special effect particle B is adjusted. Similarly, based on movement trajectories respectively corresponding to the special effect particle C and the special effect particle D, a movement area of the polyline 2 including the special effect particle C and the special effect particle D is adjusted.

For example, an animation of the strip-shaped three-dimensional model moving with the specified three-dimensional model is generated based on movement areas respectively corresponding to the plurality of polylines.

For example, the specified three-dimensional model is implemented as a virtual head, and the strip-shaped three-dimensional model is implemented as virtual hair. Movement areas of the plurality of polylines from the i^{th} moment to the (i+1)^{th} moment are determined based on movement trajectories respectively corresponding to a plurality of special effect particles on a polyline corresponding to the virtual hair. The movement area is configured for indicating an area through which the polyline passes. Movement statuses of the plurality of polylines are determined based on the areas, to generate an animation, and the animation presents an animation status of the virtual hair moving with the virtual head.

The foregoing is merely an example for illustration. This is not limited in the embodiments of the present disclosure.

In conclusion, an example in which the target polyline in the plurality of polylines is analyzed is used, and the force data respectively corresponding to the plurality of special effect particles on the target polyline is determined based on the movement speed and the movement direction of the specified three-dimensional model at the i^{th} moment, thereby calculating the speed change amounts of the special effect particles, and further determining the movement trajectories respectively corresponding to the plurality of special effect particles based on the movement speeds and the speed change amounts of the plurality of special effect particles. A problem of poor analysis efficiency caused by directly performing comprehensive analysis on a plurality of polylines is avoided. The plurality of polylines are first respectively analyzed, the speed change amounts respectively corresponding to the plurality of special effect particles on the polylines are then determined, and the plurality of polylines are further comprehensively analyzed based on analyzing the plurality of polylines respectively. In this way, calculation and analysis efficiency can be improved, an animation of a strip-shaped three-dimensional model moving with a specified three-dimensional model can be generated more instantaneously and efficiently, and timeliness of animation generation can be improved to facilitate rendering and showing of the generated animation, so that the animation generation method for a strip-shaped three-dimensional model can be applied to a wider range of scenarios.

In an exemplary embodiment, during calculation of the movement trajectories respectively corresponding to the plurality of special effect particles, a plurality of polylines are first used as target polylines respectively for separate analysis, to obtain force data respectively corresponding to the plurality of special effect particles on a target polyline based on a separate analysis process. A speed change amount determined based on the force data is related to the target polyline. In addition, special effect particles on a plurality of polylines in parallel may be analyzed in parallel, to improve analysis efficiency. For example, as shown in FIG. 3, the embodiment shown in FIG. 2 may alternatively be implemented as the following operation 310 to operation 350.

Operation 310: Determine polylines respectively corresponding to a plurality of strip-shaped three-dimensional models.

For example, the strip-shaped three-dimensional model is configured for instructing to present a strip-shaped or bar-shaped three-dimensional model, which may be implemented as virtual hair, virtual flowers and grass, virtual fur, or the like. For ease of analyzing the strip-shaped three-dimensional models, each strip-shaped three-dimensional model is considered as a polyline, to obtain polylines respectively corresponding to the plurality of strip-shaped three-dimensional models.

In addition, to facilitate analysis of a movement status of the strip-shaped three-dimensional model, a polyline corresponding to the strip-shaped three-dimensional model is divided by using a special effect particle. In other words, each polyline includes a plurality of special effect particles. The special effect particle is configured for representing a division granularity of a polyline. More special effect particles being included on a polyline indicates a smaller division granularity of the polyline.

In an exemplary embodiment, an isotropic polyline rod is used as a polyline representation corresponding to the strip-shaped three-dimensional model. In other words, a polyline has a property of being isotropical. The isotropical property is configured for representing that physical and chemical properties corresponding to the polyline do not change with different directions, and is also referred to as homogeneity.

For example, FIG. 4 is a schematic diagram of polylines corresponding to a strip-shaped three-dimensional model.

The polyline includes N special effect particles, which are represented by circles. Four special effect particles are shown in the figure, which are respectively a special effect particle 410 x₀, a special effect particle 420 x₁, a special effect particle 430 x₂, and a special effect particle x₃; and each polyline further includes N−1 particle connection edges connecting the special effect particles.

In some embodiments, each special effect particle has three degrees of freedom, and the three degrees of freedom are configured for representing a position of the special effect particle in a three-dimensional coordinate system. Each particle connection edge has one degree of freedom, and the one degree of freedom is configured for representing a rotation angle. Therefore, each polyline includes 4N−1 degrees of freedom. In other words, 4N−1=3N+N−1.

The strip-shaped three-dimensional model is bound to the specified three-dimensional model.

For example, the strip-shaped three-dimensional model is a model bound to the specified three-dimensional model. In some embodiments, when the strip-shaped three-dimensional model is implemented as virtual hair, the specified three-dimensional model may be implemented as a virtual head bound to the virtual hair.

In some embodiments, an example in which the strip-shaped three-dimensional model is implemented as virtual hair, and the specified three-dimensional model is implemented as a virtual head is used, in a three-dimensional scene including the specified three-dimensional model and the strip-shaped three-dimensional model bound thereto, an initialization operation is performed on the three-dimensional scene.

For example, a three-dimensional scene setting person imports the strip-shaped three-dimensional model corresponding to the virtual hair into the three-dimensional scene from the outside; or the three-dimensional scene setting person self-defines virtual hair in the three-dimensional scene to implement a process of importing the strip-shaped three-dimensional model. In addition, after the virtual hair is obtained, physical parameters related to the virtual hair are set. For example, a length of the virtual hair, a thickness of the virtual hair, and density of the virtual hair are set. In addition, for the polyline configured for describing the virtual hair, a quantity of special effect particles on the polyline, a mass of the special effect particle, an initial bending force corresponding to the special effect particle, an initial twisting force corresponding to the special effect particle, an initial stretching force of the particle connection edge corresponding to the special effect particle, and the like may further be set.

The foregoing physical parameters are merely an example for illustration. This is not limited in the embodiments of the present disclosure.

In addition to setting the virtual hair, the three-dimensional scene setting person further needs to select a virtual head to be bound to the virtual hair. For example, virtual hair A is bound to a virtual head corresponding to a virtual object 1.

The virtual head is implemented as a signed distance field (SDF). The SDF is a discrete representation manner of an implicit curved surface, and is essentially a 3D Cartesian grid. Each voxel of the grid stores a smallest distance to the curved surface, is configured for determining whether a voxel point is inside the curved surface, and is usually configured for representing a complex geometry during collision processing, for example, the virtual head.

In other words, the three-dimensional scene setting person selects an SDF as the head, and binds the virtual hair to the SDF, so that in subsequent simulation, a movement of the SDF drives a movement of the virtual hair.

Operation 320: For a target polyline in the plurality of polylines, determine, in response to that the specified three-dimensional model moves at an i^{th} moment, force data respectively corresponding to the plurality of special effect particles on the target polyline at the i^{th} moment based on a movement speed and a movement direction of the specified three-dimensional model.

At least one type of energy is defined on each polyline. The at least one type of energy changes based on a movement status of the specified three-dimensional model. Force data on each special effect particle is calculated based on the energy.

In some embodiments, three types of energy are defined on a polyline, including stretching energy, bending energy, and twisting energy.

The stretching energy is defined on a particle connection edge connecting special effect particles, and is configured for representing stretching between two special effect particles connected by the particle connection edge. The bending energy is defined on a special effect particle, and is configured for representing bending caused by a change of an angle between particle connection edges on two sides of the special effect particle. The twisting energy is defined on a special effect particle, and is configured for representing twisting caused by a twisting change of particle connection edges on two sides of the special effect particle in space.

In some embodiments, an example in which a force process of any special effect particle on the target polyline is analyzed is used. There are two special effect particles adjacent to the special effect particle on the target polyline. As shown in FIG. 4, two special effect particles adjacent to the special effect particle 420 are respectively the special effect particle 410 and the special effect particle 430. The special effect particle is represented as a vertex or a particle.

During calculation of the force data of the special effect particle, attributes of special effect particles adjacent to the special effect particle are determined. The force data of the particle includes a stretching force, a bending force, and a twisting force.

In an exemplary embodiment, in response to that the specified three-dimensional model moves at the i^{th} moment, stretching forces respectively corresponding to the plurality of special effect particles at the i^{th} moment are determined based on the movement speed and the movement direction of the specified three-dimensional model.

The stretching force is configured for indicating stretching of the special effect particles by two adjacent special effect particles.

In an exemplary embodiment, bending forces respectively corresponding to the plurality of special effect particles at the i^{th} moment are determined based on the movement speed and the movement direction of the specified three-dimensional model.

The bending force is configured for indicating a planar impact of two adjacent special effect particles on the special effect particle.

In an exemplary embodiment, twisting forces respectively corresponding to the plurality of special effect particles at the i^{th} moment are determined based on the movement speed and the movement direction of the specified three-dimensional model.

The twisting force is configured for indicating a spatial impact of two adjacent special effect particles on the special effect particle.

In some embodiments, FIG. 5 is a schematic diagram of special effect particles that need to be accessed for calculating force data of a special effect particle.

In some embodiments, a force of a special effect particle is determined by energy of the special effect particle and two adjacent special effect particles, and an energy of each special effect particle is determined by positions of the special effect particle and two adjacent special effect particles.

For example, the stretching force corresponding to the special effect particle is determined based on the stretching energy corresponding to the special effect particle; the twisting force corresponding to the special effect particle is determined based on the twisting energy corresponding to the special effect particle; and the bending force corresponding to the special effect particle is determined based on the bending energy corresponding to the special effect particle.

For a target special effect particle 510 xᵢ, a first special effect particle 511 xᵢ₋₁ and a second special effect particle 512 xᵢ₊₁ that are adjacent to the target special effect particle 510 xᵢ are determined. The target special effect particle may be any special effect particle. In this embodiment of the present disclosure, an example in which the target special effect particle is the special effect particle 510 xᵢ are used for description.

A first energy value corresponding to the first special effect particle 511 xᵢ₋₁ and a second energy value corresponding to the second special effect particle 512 xᵢ₊₁ are obtained; and force data of the target special effect particle 510 xᵢ is obtained based on the first energy value and the second energy value.

For example, during determining of the first energy value corresponding to the first special effect particle 511 xᵢ₋₁, a third special effect particle 513 xᵢ₋₂ adjacent to the first special effect particle 511 xᵢ₋₁ and the target special effect particle 510 xᵢ are determined; and based on relative positions of the first special effect particle 511 xᵢ₋₁, the third special effect particle 513 xᵢ₋₂, and the target special effect particle 510 xᵢ, the first energy value is obtained. The first energy value is configured for representing an energy value obtained based on bending between a particle connection edge 521 connecting the first special effect particle 511 xᵢ₋₁ and the third special effect particle 513 xᵢ₋₂ and a particle connection edge 522 connecting the first special effect particle 511 xᵢ₋₁ and the target special effect particle 510 xᵢ.

Similarly, during determining of the second energy value corresponding to the second special effect particle 512 xᵢ₋₁, a fourth special effect particle 514 xᵢ₋₂ corresponding to the second special effect particle and the target special effect particle 510 xᵢ are determined; and based on relative positions of the second special effect particle 512 xᵢ₋₁, the fourth special effect particle 514 xᵢ₋₂, and the target special effect particle 510 xᵢ, the second energy value is obtained. The second energy value is configured for representing an energy value obtained based on bending between a particle connection edge 523 connecting the second special effect particle 512 xᵢ₋₁ and the fourth special effect particle 514 xᵢ₋₂ and a particle connection edge 524 connecting the second special effect particle 512 xᵢ₊₁ and the target special effect particle 510 xᵢ.

The energy value includes at least one of a bending energy value, a twisting energy value, or a stretching energy value. In other words, the first energy value includes at least one of a first bending energy value, a first twisting energy value, or a first stretching energy value; and the second energy value includes at least one of a second bending energy value, a second twisting energy value, and a second stretching energy value.

In this way, in the foregoing manner, based on the movement speed and the movement direction of the specified three-dimensional model, at least one of the stretching force, the bending force, or the twisting force respectively corresponding to the plurality of special effect particles at the i^{th} moment is determined as the force data respectively corresponding to the plurality of special effect particles, to ensure that the determined force data can accurately reflect a force status of the special effect particle on the polyline moving with the specified three-dimensional model. In this way, it is conducive to accurately determining a movement status of the special effect particle based on the force data, to ensure accuracy of a determined movement trajectory of the special effect particle, so that a finally generated animation effect of the strip-shaped three-dimensional model is vivid and accurate.

In some embodiments, determining a bending force corresponding to a special effect particle is used as an example for description.

For any target special effect particle in the plurality of special effect particles, a first special effect particle and a second special effect particle adjacent to the target special effect particle are determined; and a first bending energy value corresponding to the first special effect particle and a second bending energy value corresponding to the second special effect particle are determined based on the movement speed and the movement direction of the specified three-dimensional model, where the first bending energy value is configured for representing a change in an angle of a particle connection edge connecting the first special effect particle and the target special effect particle, and the second bending energy value is configured for representing a change in an angle of a particle connection edge connecting the second special effect particle and the target special effect particle.

The bending force of the target special effect particle is determined based on the first bending energy value and the second bending energy value.

For example, a third special effect particle adjacent to the first special effect particle and the target special effect particle are determined; a fourth special effect particle adjacent to the second special effect particle and the target special effect particle are determined; the first bending energy value is determined based on relative positions of the first special effect particle, the third special effect particle, and the target special effect particle; and the second bending energy value is determined based on relative positions of the second special effect particle, the fourth special effect particle, and the target special effect particle.

The foregoing manner for determining the bending force is merely an example for illustration, and the twisting force and the stretching force are determined according to the foregoing method. This is not limited in the embodiments of the present disclosure.

In this way, in the foregoing manner, the bending force corresponding to the target special effect particle is determined based on the bending energy values (which are determined based on relative positions of adjacent special effect particles) respectively corresponding to the first special effect particle and the second special effect particle adjacent to the target special effect particle, to ensure that the determined bending force accurately reflects bending of the target special effect particle affected by energy of adjacent special effect particles, that is, accurately reflects a change of an angle between particle connection edges between the target special effect particle and the adjacent special effect particles. Similarly, determining the twisting force and the stretching force of the target special effect particle in a similar manner can also ensure that the determined twisting force and stretching force have high accuracy.

In some embodiments, in the foregoing manner of determining the bending force corresponding to the special effect particle, the twisting force corresponding to the special effect particle is determined through the twisting energy, and the stretching force corresponding to the special effect particle is determined through the stretching energy.

In an exemplary embodiment, the force data respectively corresponding to the plurality of special effect particles is determined based on at least one of the stretching force, the bending force, or the twisting force.

The force data is configured for representing a force status of the special effect particle on the target polyline when moving with the specified three-dimensional model.

In some embodiments, a resultant force of the bending force, the twisting force, and the stretching force is determined as the force data corresponding to the special effect particle.

For any target special effect particle in the plurality of special effect particles, a target stretching force, a target bending force, and a target twisting force corresponding to the target special effect particle are determined; and a resultant force of the target stretching force, the target bending force, and the target twisting force is determined as force data corresponding to the target special effect particle.

In this way, in the foregoing manner, the resultant force of the target stretching force, the target bending force, and the target twisting force corresponding to the target special effect particle is determined as the force data corresponding to the target special effect particle, so that the force status of the target special effect particle can be comprehensively reflected from the stretching force, the bending force, and the twisting force, to ensure that the determined force data accurately reflects a status of the target special effect particle moving with the specified three-dimensional model, making a finally generated animation effect more vivid and accurate, and consistent with a real scene.

The foregoing is merely an example for illustration. This is not limited in the embodiments of the present disclosure.

Operation 330: Calculate a speed change amount of each special effect particle on the target polyline from the i^{th} moment to an (i+1)^{th} moment based on the force data corresponding to the special effect particle.

For example, after the force data corresponding to each special effect particle on the target polyline is determined, with each special effect particle as an analysis object, a speed change amount of the special effect particle from the i^{th} moment to the (i+1)^{th} moment is calculated by using the force data.

In some embodiments, a first speed of a special effect particle corresponding to the force data at the i^{th} moment is determined.

For example, after the strip-shaped three-dimensional model is imported, a speed value of a special effect particle on the polyline corresponding to the strip-shaped three-dimensional model is recorded in real time; or after the strip-shaped three-dimensional model is imported, a speed value of the special effect particle on the polyline corresponding to the strip-shaped three-dimensional model are periodically recorded.

In some embodiments, at the i^{th} moment, a speed value of the special effect particle that needs to be analyzed is determined based on the force data, and the speed value is determined as the first speed. For example, the first speed of the special effect particle at the i^{th} moment is 1 m/s. In some embodiments, the i^{th} moment is a current moment.

In some embodiments, an acceleration of the special effect particle at the i^{th} moment is determined based on the force data.

In some embodiments, a special effect particle mass of special effect particle is obtained.

For example, the special effect particle mass may be a value set by a three-dimensional scene setting person. For example, it is set that a mass of a special effect particle A is 1, and a mass of a special effect particle B is 1.2; or a target polyline includes a special effect particle A, a special effect particle B, and a special effect particle C, a mass of the target polyline is set to 2.7, and the mass of the target polyline is evenly divided based on the three special effect particles included on the target polyline, so that masses of the special effect particle A, the special effect particle B, and the special effect particle C are all 0.9; or a target polyline includes a special effect particle A, a special effect particle B, and a special effect particle C, a mass of the target polyline is 2.7, the special effect particle A is a particle close to a specified three-dimensional model, the special effect particle B is an intermediate particle, and the special effect particle C is a particle far from the specified three-dimensional model, so that based on a preset mass allocation relationship (for example, a weight is determined based on a distance from the specified three-dimensional model), the mass of the special effect particle A is 1.3, it is determined that the mass of the special effect particle B is 0.9, the mass of the special effect particle C is 0.5.

In some embodiments, the acceleration of the special effect particle at the i^{th} moment is obtained based on the force data and the special effect particle mass.

For example, after the force data of the special effect particle and the special effect particle mass corresponding to the special effect particle are determined, the acceleration of the special effect particle at the i^{th} moment is determined based on Newton's second law.

In some embodiments, a second speed of the special effect particle at the (i+1)^{th} moment is calculated based on the first speed of the special effect particle at the i^{th} moment and the acceleration of the special effect particle at the i^{th} moment.

For example, after the recorded first speed of the special effect particle at the i^{th} moment and the acceleration of the special effect particle at the i^{th} moment are obtained, the second speed of the special effect particle at the (i+1)^{th} moment is calculated based on duration from the (i+1)^{h} moment to the i^{th} moment.

In some embodiments, the duration from the i^{th} moment to the (i+1)^{th} moment may be preset analysis duration. For example, the duration from the i^{th} moment to the (i+1)^{th} moment may be 0.3 microseconds; or the duration from the i^{th} moment to the (i+1)^{th} moment may be 0.01 microseconds; or the duration from the i^{th} moment to the (i+1)^{th} moment may be duration corresponding to a frame. The foregoing duration is merely an example for illustration, and may be flexibly adjusted in application. This is not limited in the embodiments of the present disclosure.

In some embodiments, a difference between the second speed and the first speed is determined as the speed change amount of the special effect particle from the i^{th} moment to the (i+1)^{th} moment. In this way, the speed change amounts respectively corresponding to the plurality of special effect particles on the target polyline are obtained in the foregoing manner.

For example, after the second speed is calculated, a difference between the second speed and the recorded first speed of the special effect particle at the i^{th} moment is determined, and the difference is used as the speed change amount of the special effect particle from the i^{th} moment to the (i+1)^{th} moment.

In some embodiments, based on a manner for determining the speed change amount corresponding to the special effect particle, an acceleration of a corresponding special effect particle is determined based on special effect particle masses of other special effect particles on the target polyline, to obtain second speeds respectively corresponding to the other special effect particles, and implement a process of obtaining speed change amounts respectively corresponding to the other special effect particles on the target polyline.

In this way, in the foregoing manner, based on the first speed of the special effect particle at the i^{th} moment and the acceleration of the special effect particle at the i^{th} moment that is obtained based on the force data and the special effect particle mass of the special effect particle, the second speed of the special effect particle at the (i+1)^{th} moment, and the difference between the second speed and the first speed is further calculated as the speed change amount of the special effect particle from the i^{th} moment to the (i+1)^{th} moment, so that it is ensured that the determined speed change amount has high accuracy, thereby accurately analyzing the movement status of the special effect particle.

Operation 340: Obtain speed change amounts respectively corresponding to a plurality of special effect particles on the plurality of polylines based on a parallel analysis of the plurality of polylines.

In some embodiments, based on the foregoing manner for determining the speed change amount corresponding to the special effect particle on the target polyline, speed change amounts respectively corresponding to a plurality of special effect particles on another polyline are determined. In other words, the speed change amount of the special effect particle determined in the foregoing manner is related to interaction between a plurality of special effect particles on the polyline to which the special effect particle belongs, and there is a correspondence between the speed change amount of the special effect particle, the special effect particle, and the polyline to which the special effect particle belongs.

In some embodiments, in a process of respectively analyzing the speed change amounts of the plurality of special effect particles on the plurality of polylines, the plurality of polylines are analyzed in parallel.

For example, a polyline 1, a polyline 2, and a polyline 3 in the plurality of polylines are used as an example. The polyline 1, the polyline 2, and the polyline 3 each have 50 special effect particles. In a process of respectively analyzing the speed change amounts of the plurality of special effect particles on the plurality of polylines, while the 50 special effect particles corresponding to the polyline 1 are analyzed, the 50 special effect particles corresponding to the polyline 2 are analyzed in parallel, and the 50 special effect particles corresponding to the polyline 3 are further analyzed in parallel.

The speed change amount of the special effect particle is a value obtained based on a correlation between a plurality of special effect particles on the polyline. Therefore, the foregoing process of analyzing the plurality of polylines in parallel can implement an analysis process inside a polyline, to determine a speed change amount of each special effect particle on the polyline based on a correlation between special effect particles on a single polyline; and can analyze a plurality of polylines in parallel, so that calculation efficiency is effectively improved, and a generation speed and a rendering speed of an animation effect are further improved.

In some embodiments, based on a plurality of polylines being analyzed in parallel, a plurality of special effect particles on a polyline may further be analyzed in parallel. For example, when the 50 special effect particles corresponding to the polyline 1 are analyzed, the 50 special effect particles corresponding to the polyline 1 are analyzed in parallel.

In an exemplary embodiment, a GPU computing process is performed through a compute unified device architecture (CUDA). The CUDA is a parallel computing platform and programming model that are dedicated to general computing development on the GPU, and provides a simple interface for GPU programming. In other words, the animation generation method is performed on the CUDA.

In some embodiments, each special effect particle on the polyline is processed by using a GPU thread in the CUDA, so that a large quantity of computing tasks may be processed in parallel. In addition, the following optimization solution may further be adopted to further improve processing efficiency of a parallel process.

(1) Processing Form Selected when Adjacent Special Effect Particles are Accessed

In some embodiments, adjacent special effect particles (also referred to as neighboring particles) are accessed by using a shuffle intrinsics function. The shuffle intrinsics function is an internal function set in the GPU, and is configured for performing a random operation.

For example, as shown in FIG. 5, when force data corresponding to a special effect particle is determined, for the target special effect particle 510 xᵢ, special effect particles distant from the target special effect particle 510 xᵢ by at most two special effect particles are accessed. In other words, it is determined that the third special effect particle 513 xᵢ₋₂ and the fourth special effect particle 513 xᵢ₊₂ which are spaced apart from the target special effect particle 510 xᵢ by one special effect particle are the furthest special effect particles that can be accessed.

Based on the foregoing access feature, a process of accessing adjacent special effect particles may be implemented by using shuffle intrinsics of the GPU. The method is much faster than a manner of using a shared memory.

Because based on a storage characteristic of a shared memory manner, when adjacent special effect particles are analyzed, attributes of the adjacent special effect particles need to be first written into a shared memory, and then the attributes are read from the shared memory. Consequently, the adjacent special effect particles cannot be efficiently analyzed due to an inherent characteristic of write and read of the shared memory.

In addition, because the shuffle intrinsics set in the GPU accesses a register of the GPU, a read and write speed of the shuffle intrinsics method is faster than a read and write speed of the shared memory. In this way, a processing speed of adjacent special effect particles is improved by using the shuffle intrinsics.

### (2) GPU Thread Adjustment

For example, when calculation of each special effect particle is processed by a GPU thread, it may be determined that each polyline is processed by the same GPU thread block.

A software architecture of the CUDA includes a grid, a thread block, and a thread, which is equivalent to dividing calculation units on a GPU into several (for example, 2 or 3) grids, each grid including several (for example, 65535) thread blocks, each thread block including several (for example, 512) threads.

Generally, a CUDA parallel program is executed by a plurality of threads; and a plurality of threads form a thread block, and a plurality of threads in the same thread block may be synchronous or may communicate with each other by using a shared memory. In addition, 32 consecutive threads form a thread warp, and in a thread warp, all threads execute the same instruction.

In some embodiments, to improve GPU occupancy and adapt to an implementation scenario, a method of properly reducing a quantity of polylines that need to be analyzed may be adopted, and an interpolation method may be adopted to determine a position of another polyline.

In some embodiments, a first quantity of polylines are obtained from the plurality of polylines; and speed change amounts respectively corresponding to a plurality of special effect particles on the first quantity of polylines are obtained.

For example, polylines respectively corresponding to a plurality of strip-shaped three-dimensional models are determined, some polylines (a first quantity of polylines) are selected therefrom for more precise analysis (the foregoing force data analysis, speed change amount analysis, and the like), and a polyline position (a movement area) is determined.

In some embodiments, a second quantity of polylines other than the first quantity of polylines are obtained from the plurality of polylines.

For example, in addition to obtaining the first quantity of polylines from the plurality of polylines, polylines other than the first quantity of polylines in the plurality of polylines are determined as the second quantity of polylines. In other words, the remaining polylines are determined as the second quantity of polylines.

In some embodiments, an interpolation operation is performed based on the speed change amounts respectively corresponding to the plurality of special effect particles on the first quantity of polylines, to obtain interpolated speed change amounts respectively corresponding to the second quantity of polylines as the speed change amounts respectively corresponding to the plurality of special effect particles on second quantity of polylines.

For example, positions of the remaining polylines are determined with help of the some polylines that are accurately analyzed. For example, assuming that there are 10000 strip-shaped three-dimensional models in total, corresponding to 10000 polylines, 500 to 2000 polylines are selected therefrom as polylines for accurate analysis, and a polyline for accurate analysis may be referred to as a simulated polyline (for example, when the strip-shaped three-dimensional model corresponding to the polyline is virtual hair, the simulated polyline may be referred to as simulated hair); and the remaining polylines (that is, other polylines than the polyline that is accurately analyzed in all the polylines) are referred to as interpolated polylines (for example, when the strip-shaped three-dimensional model corresponding to the polyline is virtual hair, the interpolated polyline may be referred to as interpolated hair). In other words, an interpolated polyline is obtained through interpolation based on a simulated polyline accurately analyzed.

In some embodiments, based on the speed change amount and an interpolated speed change amount, the movement trajectories respectively corresponding to the plurality of special effect particles are calculated.

For example, movement areas of a first quantity of polylines (namely, simulated polylines) are determined based on speed change amounts. In addition, movement areas of a second quantity of polylines (namely, interpolated polylines) are determined based on interpolated speed change amounts, to obtain the movement trajectories respectively corresponding to the plurality of special effect particles.

In the foregoing process, some polylines are selected as simulated polylines for accurate analysis, thereby reducing a quantity of GPU threads for processing speed change amounts of special effect particles on the polylines. Therefore, occupancy of a GPU is not excessively high, and a problem of excessively large consumption of the GPU is greatly avoided. In addition, based on speed change amounts of the special effect particles on the simulated polylines, an interpolation operation is performed on the remaining interpolated polylines that are not accurately analyzed, to obtain speed change amounts corresponding to the special effect particles on the interpolated polylines, to ensure accuracy of speed change amounts of special effect particles on each polyline in a case that consumption of excessive GPU resources are avoided.

In some embodiments, special effect particles on each polyline may be further divided into a plurality of groups (namely, a plurality of thread warps). Based on a property of a thread warp, each group includes 32 consecutive special effect particles, and each group is handed over to a different GPU thread block for processing. For example, for a polyline including 50 special effect particles, two GPU thread blocks are needed for processing. Therefore, when a quantity of special effect particles included on the polyline is large, the occupancy of the GPU may also be improved in a processing manner by using different GPU thread blocks.

The foregoing is merely an example for illustration. This is not limited in the embodiments of the present disclosure.

### (3) Group Adjustment of Special Effect Particles

For example, in a process of processing special effect particles based on threads in a GPU, a thread divergence problem may exist. The thread divergence is configured for representing a divergence generated due to inconsistent executed instructions of the same GPU thread warp.

In some embodiments, if after the special effect particles on each polyline are grouped into a plurality of thread warps including 32 consecutive special effect particles for processing, each thread warp is referred to as a group, special effect particles located at two ends cannot directly access adjacent special effect particles (neighboring particles) thereof, and an additional read and write operation is usually needed to implement an obtaining process.

For example, FIG. 6 is a grouping result obtained through directly grouping the special effect particles. A first group 610 is represented as a Groupⱼ₋₁, a second group 620 is represented as a Groupⱼ, and a third group 630 is represented as a Groupⱼ₊₁. Based on the manner for determining the force data shown in FIG. 5, force data respectively corresponding to different special effect particles is determined by using adjacent special effect particles. Using a special effect particle i in the second group 620 as an example, if force data of the special effect particle i is determined, the force data needs to be determined by using energy of a special effect particle i−1 that does not belong to the second group 620 but belongs to the first group 610. Similarly, using the special effect particle i−1 in the first group 610 as an example, if force data of the special effect particle i−1 is determined, the force data needs to be determined by using energy of the special effect particle i that does not belong to the first group 610 but belongs to the second group 620. Because a process of determining the force data needs to be implemented by using an additional read and write operation between different thread warps, a form of direct grouping has a problem of low efficiency.

In some embodiments, based on the foregoing process, an impact of the foregoing problem is alleviated by designing an overlapping grouping manner.

For example, FIG. 7 shows a grouping result obtained through grouping special effect particles in the overlapping grouping manner. A first group 710 is represented as a Groupⱼ, and a second group 720 is represented as a Groupⱼ₊₁. In the overlapping grouping, two special effect particles on a boundary of each group are processed by two different thread blocks. Although only a part of results can be calculated by the two thread blocks, results of the two thread blocks are complementary, and a correct result is obtained by adding the results.

For example, a special effect particle i+30 and a special effect particle i+31 in the first group 710 may also occur in the second group 720 in an overlapping manner. An example in which the special effect particle i+31 is analyzed is used. Based on the manner for determining the force data shown in FIG. 5, when the special effect particle i+31 is processed by the first group 710, the special effect particle i+31 can only obtain a contribution (which is an energy contribution) from the special effect particle i+30, and contributions from the special effect particle i+31 and the special effect particle i+32 are directly set to 0. When the special effect particle i+31 is processed by the second group 720, the special effect particle i+31 may obtain contributions from the special effect particle i+31 and the special effect particle i+32, and a contribution from the special effect particle i+30 is set to 0. Results of the first group 710 and the second group 720 are added (where an atomic adding method is used), to correctly obtain the contributions from the special effect particle i+31 and two adjacent special effect particles thereof, to obtain a correct result. Although an atomic operation is used, a frequency is low, and therefore, processing efficiency is not greatly affected.

### (4) Combine Write Process

For example, during solving of the speed change amount, a process of calculating the second speed and determining the speed change amount is implemented by using a discrete elastic rod (DER) of semi-implicit integration. A simple summary of a main task of the semi-implicit integral DER is: calculating current force data of each special effect particle, calculating an acceleration of each special effect particle at a current moment, and then calculating a second speed of each special effect particle at a next moment. In this way, a speed change amount Δu in this time step (which is the i^{th} moment i to the (i+1)^{th} moment) is obtained.

In some embodiments, the foregoing process of solving the semi-implicit integral DER is generalized as solving of the following Formula 1.

$$( M + {h}^{2} H ) u = {Mu}_{0} + hf \qquad Formula 1$$

M is configured for representing a special effect particle mass matrix of a plurality of special effect particles on a polyline on which a solved special effect particles is located; h is configured for representing a time step length (which is duration from the moment i to the moment i+1); H represents a derivative of f; u represents a second speed that needs to be solved; u₀ represents a first speed of the solved special effect particle at a current moment; and f represents force data of the solved special effect particle.

In some embodiments, for ease of subsequent description, (M+h²H) on the left of Formula 1 is referred to as a left hand side (LHS); and Mu₀+hf on the right of Formula 1 is referred to as a right hand side (RHS). The second speed u is solved through the LHS and the RHS, to obtain the speed change amount Δu.

An LHS of each polyline is a (4n−1)*(4n−1) matrix, where n is configured for representing a quantity of special effect particles on the polyline, and a calculation result of each special effect particle is a part of the matrix.

For example, a calculation result of an i^{th} special effect particle is a sub-matrix {{4i−1, 4i−1}, {4i+3, 4i+3}}. When a calculation result is stored in a global memory, based on a requirement, indicated by the global memory, of sequentially storing the special effect particles, if a memory of each special effect particle is more than 100 bytes, there are more than 100 bytes between data of each special effect particle at a same position. Consequently, if once a result of a special effect particle is calculated, the result is written to the global memory, a requirement of a GPU for coalesced access is not satisfied, and a write process is caused to be extremely slow.

In some embodiments, a shared memory is used as an intermediate layer, and calculation results of adjacent special effect particles (such as energy of the adjacent special effect particles) are stored into the shared memory, until calculation results of all the special effect particles are calculated jointly, and all calculation results are uniformly written into the global memory. When the calculation results are uniformly written into the global memory, a sequence of writing into the global memory does not need to be particularly concerned about. Adjacent data in the global memory is processed by using adjacent threads, and the calculation results corresponding to the special effect particles do not need to be analyzed strictly in a sequence of the adjacent special effect particles, thereby greatly accelerating the writing process.

The foregoing is merely an example for illustration. This is not limited in the embodiments of the present disclosure.

In an exemplary embodiment, Formula 1 may be solved by using an LDL decomposition method.

LDL decomposition is a variation of Cholesky decomposition, and is to decompose a symmetric positive-definite matrix into a product of a lower triangular matrix L, a diagonal matrix D, and a transpose of L. For implementation of the LDL decomposition on the GPU, the following optimization solution may be adopted.

Because the LHS of Formula 1 is a band matrix with a bandwidth of 10, a lower triangular matrix obtained through decomposition is also a band matrix with a bandwidth of 10. Further, 10 threads may be used to process a polyline. Because a GPU thread warp includes 32 threads, a GPU thread warp may be configured to process three polylines simultaneously. In this way, data of an adjacent thread of a thread is also obtained through shuffle intrinsics. The matrix L is stored in column-major order, so that the matrix L may be merged when a calculation result is written. However, a side effect of the process is that after the matrix is written, the process cannot be merged and read.

In some embodiments, the shared memory is used to store the latest 10 columns of data. The 10 columns of data are data that are to be used by a current thread, to avoid repeated unmerged reading.

The foregoing is merely an example for illustration. This is not limited in the embodiments of the present disclosure.

In some embodiments, after Formula 1 is solved based on the foregoing process, the second speed u is obtained, and the speed change amount du is further solved.

Operation 350: Calculate movement trajectories respectively corresponding to the special effect particles on the plurality of polylines based on movement speeds of the special effect particles on the plurality of polylines at the i^{th} moment and speed change amounts of the special effect particles on the plurality of polylines from the i^{th} moment to the (i+1)^{th} moment, and generate, based on the movement trajectories, an animation of the plurality of strip-shaped three-dimensional models moving with the specified three-dimensional model.

For example, based on Formula 1, speed change amounts respectively corresponding to a plurality of special effect particles on the same polyline are determined based on masses of the plurality of special effect particles on the same polyline and the force data corresponding to the special effect particles.

In addition, based on Formula 1, a plurality of polylines are respectively analyzed in parallel, and speed change amounts respectively corresponding to a plurality of special effect particles on the same polyline are determined by using masses of the plurality of special effect particles on the polyline and force data corresponding to the special effect particles, to obtain movement speeds of the special effect particles and speed change amounts of the special effect particles on the plurality of polylines.

For example, for each special effect particle, after the movement speed and the speed change amount corresponding to the special effect particle are determined, a sum of the movement speed and the speed change amount is calculated, to obtain an adjusted speed respectively corresponding to each special effect particle. In other words, first adjusted speeds respectively corresponding to a plurality of special effect particles on a plurality of polylines are obtained.

In some embodiments, the movement trajectories respectively corresponding to the plurality of special effect particles are determined based on the first adjusted speeds.

For example, first adjusted speeds respectively corresponding to a plurality of special effect particles at a plurality of moments within a preset time period are determined based on the foregoing method, and movement trajectories respectively corresponding to the plurality of special effect particles are obtained based on the first adjusted speeds respectively corresponding to the plurality of special effect particles at the plurality of moments. For example, a movement trajectory of a special effect particle A from a moment 1 to a moment 3 is obtained based on a first adjusted speed a1 of the special effect particle A at the moment 1, a first adjusted speed a2 of the special effect particle A at the moment 2, and a first adjusted speed a3 of the special effect particle A at the moment 3.

In some embodiments, after the first adjusted speeds are obtained, the plurality of special effect particles on the plurality of polylines are comprehensively analyzed, to determine a collision status between the plurality of special effect particles, the first adjusted speeds respectively corresponding to the plurality of special effect particles are adjusted based on the collision status, to obtain second adjusted speeds, and the movement trajectories respectively corresponding to the plurality of special effect particles are determined based on the second adjusted speeds.

For example, second adjusted speeds respectively corresponding to a plurality of moments within a preset time period are determined based on the foregoing method, and movement trajectories respectively corresponding to the plurality of special effect particles are obtained based on the second adjusted speeds respectively corresponding to a plurality of special effect particles at the plurality of moments.

In an exemplary embodiment, a plurality of movement trajectory animation frames are generated by using the movement trajectories respectively corresponding to the plurality of special effect particles.

For example, after movement trajectories respectively corresponding to a plurality of special effect particles, based on movement trajectories of special effect particles on the same polyline, a movement range of the polyline is determined, and movement ranges respectively corresponding to a plurality of polylines are determined based on the method.

In some embodiments, if the plurality of polylines includes a first quantity of polylines for accurate analysis and a second quantity of polylines for interpolation analysis, movement ranges respectively corresponding to the first quantity of polylines are determined based on movement trajectories of special effect particles on the first quantity of polylines, and interpolated movement ranges respectively corresponding to the second quantity of polylines are determined based on interpolated movement trajectories of special effect particles on the second quantity of polylines. A plurality of movement trajectory animation frames are generated based on the movement ranges and the interpolated motion ranges, and the plurality of movement trajectory animation frames present an animation process in which the plurality of polylines move with a specified three-dimensional model.

In some embodiments, the plurality of movement trajectory animation frames are generated to obtain an animation of the strip-shaped three-dimensional model moving with the specified three-dimensional model.

For example, after the plurality of movement trajectory animation frames that instructs the strip-shaped three-dimensional model to move with the specified three-dimensional model are generated, the animation is formed by the plurality of movement trajectory animation frames in time sequence. The animation shows a movement status of the strip-shaped three-dimensional model moving with the specified three-dimensional model.

In this way, in the foregoing manner, a movement trajectory animation frame is generated based on the movement trajectories respectively corresponding to the plurality of special effect particles, and an animation representing that the strip-shaped three-dimensional model moves with the specified three-dimensional model is generated based on the plurality of movement trajectory animation frames. In this way, the animation is generated frame by frame, to ensure that the generated animation is vivid and accurate, and conforms to a real scene.

The foregoing is merely an example for illustration. This is not limited in the embodiments of the present disclosure.

In conclusion, according to the foregoing method, a problem of poor analysis efficiency caused by directly performing comprehensive analysis on a plurality of polylines is avoided. The plurality of polylines are first respectively analyzed, the speed change amounts respectively corresponding to the plurality of special effect particles on the polylines are determined, and the plurality of polylines are further comprehensively analyzed based on analyzing the plurality of polylines respectively. In this way, calculation and analysis efficiency can be improved, an animation of a strip-shaped three-dimensional model moving with a specified three-dimensional model can be generated more instantaneously and efficiently, and timeliness of animation generation can be improved, so that the animation generation method for a strip-shaped three-dimensional model can be applied to a wider range of scenarios.

In this embodiment of the present disclosure, content of analyzing a plurality of polylines in parallel is described. Special effect particles on a plurality of polylines are first separately analyzed, and force data respectively corresponding to the plurality of special effect particles is then obtained based on the separate analysis. A speed change amount determined based on the force data is related to a polyline corresponding to the special effect particle. In addition, analysis efficiency may be improved by analyzing a plurality of polylines in parallel, thereby greatly avoiding inefficiency of uniformly analyzing a plurality of special effect particles corresponding to a plurality of polylines.

In an exemplary embodiment, during calculation of the movement trajectories based on the movement speeds of the special effect particles on the plurality of polylines and the speed change amounts of the special effect particles, the movement trajectories corresponding to the special effect particles are obtained through a mapping conversion relationship between a special effect grid space and the special effect particles. For example, as shown in FIG. 8, the operation 240 shown in FIG. 2 may alternatively be implemented as the following operation 810 to operation 830.

Operation 810: Fuse a speed change amount of a target special effect particle from the i^{th} moment to the (i+1)^{th} moment with a movement speed of the target special effect particle at the i^{th} moment, to obtain a first adjusted speed of the target special effect particle.

For example, the target special effect particle is configured for indicating any special effect particle of a plurality of special effect particles on a plurality of polylines. For example, a polylines are obtained in total based on a strip-shaped three-dimensional models, and each polyline includes b special effect particles, so that there are a*b special effect particles in total, and a target special effect particle is any one of the a*b special effect particles.

Based on the foregoing calculation process of the speed change amount, the special effect particles on each polyline are respectively analyzed, to obtain speed change amounts reflecting interaction between the special effect particles on each polyline, for example, speed change amounts respectively corresponding to b special effect particles on a polyline a₁ in the a polylines reflect interaction between the b special effect particles on the polyline a₁.

In some embodiments, after a speed change amount of any target special effect particle in the plurality of special effect particles from the i^{th} moment to the (i+1)^{th} moment is calculated, and a movement speed (which is the first speed value) of the target special effect particle at the i^{th} moment is recorded, a summation operation is performed on the speed change amount of the target special effect particle and the movement speed of the target special effect particle, to obtain the first adjusted speed of the target special effect particle.

The first adjusted speed is configured for representing a movement status of the target special effect particle at a sub-moment between the i^{th} moment and the (i+1)^{th} moment.

In some embodiments, after the speed change amount of the target special effect particle from the i^{th} moment to the (i+1)^{th} moment is calculated, and the movement speed corresponding to the target special effect particle at the i^{th} moment is recorded, an equal step length N of the speed change amount is set. In other words, the speed change amounts are evenly divided by using the equal step length N. For example, the speed change amount du is evenly divided into N parts, to obtain N sub-change amounts Au/N, and when the speed change amount of the target special effect particle is merged with the movement speed of the target special effect particle at the i^{th} moment, the N sub-change amounts Au/N is merged with the movement speed of the target special effect particle at the i^{th} moment, to obtain the first adjusted speed of the target special effect particle.

For example, interval duration between the i^{th} moment and the (i+1)^{th} moment is referred to as Δt. Δt is divided based on the equal step length N, to obtain N sub-durations Δt/N. When an (i+Δt/N)^{th} moment (namely, the first Δt/N duration) is analyzed, Δu/N is merged with the movement speed of the target special effect particle at the i^{th} moment, to obtain a first adjusted speed of the target special effect particle at the (i+Δt/N)^{th} moment. Similarly, during analysis of an (i+2*Δt/N)^{th} moment (namely, the second Δt/N duration), 2Δu/N is merged with the movement speed of the target special effect particle at the i^{th} moment, to obtain a first adjusted speed of the target special effect particle at the (i+2*Δt/N)^{th} moment. In other words, the first adjusted speed of the target special effect particle is a speed obtained through adding Δu/N and the movement speed of the target special effect particle at the i^{th} moment.

Operation 820: Obtain first adjusted speeds respectively corresponding to a plurality of special effect particles on the plurality of polylines.

For example, according to the method for obtaining the first adjusted speed of the target special effect particle, calculation is respectively performed on the plurality of special effect particles on the plurality of polylines. In other words, the plurality of special effect particles are respectively used as the target special effect particles, to obtain the first adjusted speeds respectively corresponding to the plurality of special effect particles on the plurality of polylines.

Operation 830: Determine movement trajectories respectively corresponding to the special effect particles on the plurality of polylines based on a plurality of first adjusted speeds of the special effect particles on the plurality of polylines within a preset time period.

For example, after the first adjusted speeds respectively corresponding to the plurality of special effect particles on the plurality of polylines are obtained, collision detection is performed on the plurality of special effect particles in combination.

For example, assuming that the plurality of special effect particles on the plurality of polylines are a*b special effect particles, after first adjusted speeds respectively corresponding to the a*b special effect particles are obtained, collision detection is performed on the a*b special effect particles, to adjust the first adjusted speeds.

In an exemplary embodiment, the collision detection is a process implemented through a material point method (MPM). The material point method is a classic physical simulation method of a hybrid Euler-Lagrange perspective. A basic idea of the MPM method is combining a material point (implemented as a special effect particle in the embodiments of the present disclosure) and a grid (represented as a special effect grid space below). The special effect particle is adhered to a node in the special effect grid space, so that the special effect particle can move along the special effect grid space. In addition, a state quantity of the special effect particle is transmitted to the special effect grid space through an interpolation method, thereby implementing a combination of a Euler grid method and a Lagrange gridless method.

Therefore, the plurality of polylines are located in the special effect grid space, and the special effect particles respectively corresponding to the plurality of polylines are located in the special effect grid space.

The special effect grid space is an analysis space projected when the special effect particle is analyzed. As shown in FIG. 4, a large rectangular area 440 is an illustrative representation of a special effect grid space; and a plurality of small rectangular areas (such as a small rectangular area 441) is an area obtained through division based on a division granularity of the special effect grid space.

In this way, in the foregoing manner, a corresponding first adjusted speed is determined for each special effect particle on the plurality of polylines. In other words, a single polyline is considered first, a movement status of a special effect particle on the polyline to which the special effect particle belongs is determined, and comprehensive force analysis is then performed on the plurality of polylines. The first adjusted speed corresponding to the special effect particle on the polyline is adjusted through a collision detection mechanism, to determine a movement status of the special effect particle in a case that the plurality of polylines interact with each other. In this way, accuracy of a determined movement trajectory of the special effect particle is ensured. In addition, a mechanism of single-polyline analysis first and then overall multi-polyline analysis may effectively improve calculation efficiency.

In an exemplary embodiment, the first adjusted speeds respectively corresponding to the plurality of special effect particles are bound to the corresponding special effect particles, to obtain a plurality of binding results.

An m^{th} special effect particle is bound to a corresponding m^{th} first adjusted speed, where m is a positive integer.

For example, through a process of binding a first adjusted speed to a corresponding special effect particle, an association relationship between the first adjusted speed and the corresponding special effect particle is established, and a plurality of binding results are obtained.

In an exemplary embodiment, the plurality of binding results are mapped to the special effect grid space for particle collision detection, to obtain movement trajectories corresponding to the special effect particles within the preset time period.

The preset time period includes a plurality of moments including the i^{th} moment.

In some embodiments, the plurality of binding results are mapped to the special effect grid space.

In some embodiments, the second adjusted speeds respectively corresponding to the plurality of special effect particles are obtained by processing the plurality of binding results through the special effect grid space.

For example, in the special effect grid space, the plurality of binding results are processed through a grid-solve method. For example, the grid-solve method includes manners such as speed projection and divergence projection, and association between special effect particles is strengthened through a grid operation.

In some embodiments, a second adjusted speed corresponding to the special effect particle in the plurality of second adjusted speeds is mapped to the special effect particle, to obtain a movement trajectory corresponding to the special effect particle within the preset time period.

For example, the first adjusted speed determined is adjusted based on the polyline, so that the second adjusted speed obtained after adjustment can present a force relationship between a plurality of special effect particles on the same polyline, and can present a random collision relationship between the plurality of special effect particles on the plurality of polylines, to improve systematicness of the special effect particle analysis through a sequential analysis process. After the second adjusted speed corresponding to a special effect particle in the plurality of second adjusted speeds is mapped to the special effect particle, the movement trajectory corresponding to the special effect particle is obtained, and a movement trajectory of the strip-shaped three-dimensional model corresponding to the polyline moving with the specified three-dimensional model is further obtained.

In this way, the binding result between the special effect particle and the corresponding first adjusted speed is mapped to the special effect grid space, and the collision simulation is performed in the special effect grid space based on the binding result, to ensure that a movement trajectory obtained through the collision simulation has high accuracy. In addition, performing the collision simulation in the special effect grid space helps improve the efficiency of the collision simulation.

The foregoing is merely an example for illustration. This is not limited in the embodiments of the present disclosure.

In an exemplary embodiment, after the speed change amount of the special effect particle from the i^{th} moment to the (i+1)^{th} moment is calculated by using a DER method, collision detection analysis is implemented by using the MPM method.

In some embodiments, because implicit integration is used in the DER method, and explicit integration is used in the MPM method, a time step of the DER method may be longer than a time step of the MPM method. Therefore, after the speed change amount of the special effect particle from the i^{th} moment to the (i+1)^{th} moment is obtained through calculation by using the DER method, a multi-step MPM method needs to be calculated. In this way, calculation efficiency is also improved.

For example, to synchronize a single-step DER and a multi-step MPM, the speed change amount Δu calculated by using the DER method is evenly divided into N equal parts, where N is a step quantity of the MPM. Each time before the MPM is calculated, the speed change amount Δu is applied to a first speed u of the special effect particle, and MPM calculation is then performed. For example, MPM calculation is performed on a sum of the speed change amount Δu corresponding to a special effect particle A and a first speed u of the special effect particle A, where the first speed u is a movement speed of the special effect particle at the i^{th} moment.

FIG. 9 is a schematic diagram of comparison between step lengths of time steps. A step length corresponding to an MPM method 910 is Δt. Correspondingly, if a step quantity of the MPM method is N, a time step of a DER method 920 is NΔt.

Similarly, movement of the specified three-dimensional model (which is, for example, determined by using an SDF method) needs to be particularly considered. During calculation of the DER, a state of the SDF needs to be a state at t+NΔt, and during calculation of an i^{th} step of the MPM, the state of the SDF needs to be a state at t+iΔt, where t is any moment, for example, the foregoing i^{th} moment.

In an exemplary embodiment, to simulate a fluffy feeling of hair, a physical model of water or sand may be used as the strip-shaped three-dimensional model at an MPM stage.

The physical model of water or sand can protect a special effect particle on a polyline corresponding to the strip-shaped three-dimensional model. In addition, the physical model of sand may also simulate a friction force, and therefore, may be applied to a strip-shaped three-dimensional model that is not excessively smooth, for example, is applied to virtual hair.

In an exemplary embodiment, in an original MPM method, a person model with a complex mesh may be used as a collider, to interact with a special effect particle.

In some embodiments, to improve real-time efficiency, an analytic collider (analytic SDF) may be selected as the specified three-dimensional model in an algorithm framework in this embodiment of the present disclosure. For example, a sphere, a cuboid, a cylinder, and a capsular body. An animation update speed of the analytic colliders is fast, improving simulation efficiency.

In an exemplary embodiment, in a real-time scene such as a game, simulation stability is important. For example, according to the DER method and the MPM method, sometimes only a mathematical expression of a problem in an ideal case is considered, and a problem that an engineering practice may encounter is not considered.

For example, a concept referred to as a curvature binormal is introduced into the DER method, and a definition formula of the curvature binormal is shown in the following Formula 2.

$${( kb )}_{i} = \frac{2 {t}^{i - 1} * {t}^{i}}{1 + {t}^{i - 1} * {t}^{i}} \qquad Formula 2$$

t is a tangent line, i−1 and i are subscripts of an edge. When an angle between two adjacent particle connection edges is close to 180°, the curvature binormal is infinity. This causes a simulation explosion.

In some embodiments, a minimum value of a denominator of the curvature binormal formula in Formula 2 is limited to a non-zero value (for example, 0.01), to avoid obtaining a huge curvature binormal. This process does not significantly affect a simulated visual effect. In other words, in the foregoing process, all particle connection edges that may cause a simulation explosion are found as bad cases, and targeted processing shown in Formula 2 is performed, thereby avoiding affecting simulation stability.

In an exemplary embodiment, a trajectory route is randomly generated.

The trajectory route is configured for instructing the specified three-dimensional model to move along the trajectory route. As shown in FIG. 10, an irregular trajectory route 1010 is randomly generated. Any point is used as a start point of the trajectory route, and the trajectory route is generated through random direction changing transformation (for example, at least one change of direction) and reaches an end point.

In some embodiments, the specified three-dimensional model is controlled to move along the trajectory route.

For example, as shown in FIG. 10, after the trajectory route is obtained, a specified three-dimensional model 1020 (for example, a virtual head) is controlled to move along the trajectory route. In a movement process, the strip-shaped three-dimensional model (for example, virtual hair) bound to the specified three-dimensional model 1020 moves with the specified three-dimensional model, and a movement trajectory of the strip-shaped three-dimensional model is determined through the foregoing process, so that a stability test process is performed on the movement process of the specified three-dimensional model by using the randomly generated trajectory route.

In other words, in the stability test process, the strip-shaped three-dimensional model is controlled to rapidly move along the randomly generated trajectory route, and rotation of the specified three-dimensional model is continuously changed randomly. In this way, operation continues for hundreds of hours to ensure that the simulation does not explode.

The foregoing is merely an example for illustration. This is not limited in the embodiments of the present disclosure.

In conclusion, a problem of poor analysis efficiency caused by directly performing comprehensive analysis on a plurality of polylines is avoided. The plurality of polylines are first respectively analyzed, the speed change amounts respectively corresponding to the plurality of special effect particles on the polylines are determined, and the plurality of polylines are further comprehensively analyzed based on analyzing the plurality of polylines respectively. In this way, calculation and analysis efficiency can be improved, an animation of moving with a specified three-dimensional model can be generated more instantaneously and efficiently, and timeliness of animation generation can be improved, so that the animation generation method for a strip-shaped three-dimensional model can be applied to a wider range of scenarios.

In this embodiment of the present disclosure, a process of obtaining the movement trajectories corresponding to the special effect particles by using the mapping conversion relationship between the special effect grid space and the special effect particles is described. After the first adjusted speeds corresponding to the plurality of special effect particles on the polyline are obtained, the first adjusted speeds are adjusted by analyzing the collision relationships between the plurality of special effect particles. The first adjusted speeds are adjusted twice in sequence to make the analysis process of the special effect particles more organized, thereby ensuring the generation stability of the movement trajectory and improving the generation efficiency of the movement trajectory.

In an exemplary embodiment, in a process in which the animation generation method is applied to a trajectory generation process of virtual hair, the specified three-dimensional model is implemented as a virtual head, and the strip-shaped three-dimensional model is implemented as the virtual hair bound to the virtual head. The animation generation method is referred to as “a frame for efficiently and stably computing a hair animation”. In other words, a generation algorithm framework for simulating movement of virtual hair is constructed based on the animation generation method. For example, as shown in FIG. 11, the animation generation method may alternatively be implemented as the following operation 1110 to operation 1130.

Operation 1110: Update boundary condition.

The update boundary condition is configured for instructing to update a boundary condition of a current time step. To be specific, updating a state of a virtual environment at the current time step, including a specified three-dimensional model and a strip-shaped three-dimensional model. For example, a virtual head is the head of a virtual object A, and the update boundary condition is configured for representing a condition for updating a virtual environment in which the virtual object A is located.

The boundary condition includes a state of a current physical world (such as a gravity and a user-defined force field), a movement state (such as a position and rotation) of a rigid body (such as a virtual body and a virtual item in a virtual environment) in the physical world, a movement state (such as a position and rotation) of a virtual head bound to virtual hair, and the like.

In some embodiments, movement of a virtual hair root (a root of virtual hair) caused based on movement of the virtual head may also be performed herein.

Operation 1120: Semi-implicit integration.

For example, the implicit integral DER is configured for calculating, for each virtual hair, a speed change amount Δu of special effect particles on each virtual hair within a time step Δt (from the i^{th} moment to the (i+1)^{th} moment) based on interaction between a plurality of special effect particles on the single virtual hair, without considering special effect particle collision of the virtual hair and special effect particle collision between virtual hairs.

The foregoing process resolves a problem of collision between virtual hair and another rigid body in a virtual environment. For content of the semi-implicit integral DER, refer to operation 340. Details are not described herein again.

Operation 1130: Explicit integration.

After the speed change amounts respectively corresponding to the plurality of special effect particles on the virtual hair are determined based on the semi-implicit integral DER, an explicit integral MPM method is used, particle connection edges between the plurality of special effect particles on the virtual hair are ignored, the special effect particles on the virtual hair are used as discrete special effect particles, and MPM simulation is performed on the special effect particles N times within a DER time step, to determine a movement trajectory based on collision between a plurality of special effect particles on a plurality of polylines.

In some embodiments, after the speed change amount is determined, when any one of N times of MPM simulation is performed, current MPM simulation is performed by using 1/N of the speed change amount obtained in a previous stage, and the movement trajectory of the special effect particle is determined.

The explicit integration includes a process of mapping a special effect particle to a special effect grid space (particle to grid (P2G)), a grid processing process, and a process of mapping a special effect grid space to a special effect particle (grid to particle (G2P)).

The foregoing is merely an example for illustration. This is not limited in the embodiments of the present disclosure.

In an exemplary embodiment, the DER method and the MPM method are combined to obtain an algorithm framework. Algorithm logic of the algorithm framework is implemented as logic for determining the movement trajectory corresponding to the special effect particle.

For example, an initial state of virtual hair, a state of a virtual environment in which the virtual hair is located, a state of a boundary condition, an additional specified constraint condition, and the like are used as an input, a frame sequence of movement of the virtual hair is calculated as an output, and the foregoing algorithm framework is connected, through a code interface adapted to the algorithm framework, to a scene selected by a user, to obtain an animation of the virtual hair moving with virtual head.

In some embodiments, several application scenarios to which the foregoing algorithm framework can be applied are illustratively described.

(1) A parameter of virtual hair and a movement status of the virtual head are self-defined in a preset virtual scene. For example, a movement trajectory of the virtual head within a period of time is designated in advance, and a program corresponding to the virtual scene is run after everything is ready, to obtain an animation of the virtual hair moving with the virtual head within the period of time. The animation is then imported into other 3D scene processing software for subsequent processing.

(2) In a game engine or other similar 3D processing software, the algorithm framework is imported into the game engine through the code interface, and is further encapsulated and exposed to a user of the game engine for use.

(3) The algorithm framework is directly used in a game engine, a movement trajectory of the virtual hair in a game scene is calculated by using the algorithm framework when the engine is updated, and an animation obtained through generation is updated in real time. Because of high efficiency of the algorithm framework, it is not difficult to apply the algorithm framework in a similar real-time scene.

In some embodiments, after the algorithm framework is encapsulated in the game engine (Unreal Engine), the overall setting of a plug-in (Physion Groom) is obtained, as shown in FIG. 12, which is a flowchart of encapsulating the algorithm framework in Unreal Engine to obtain Physion Groom and operating Physion Groom.

Operation 1210: Import a parameter of virtual hair.

For example, existing database parameters are imported into an Unreal Engine content browser (for example, importing through a database migration tool Alembic). A general standard parameter format of the virtual hair is Strand-based. After importing, Alembic automatically converts into Groom assets.

In some embodiments, generally, different areas and different hair styles may be formed into different “hair blocks”, stored as Alemic, and imported into the engine.

Operation 1220: Add overall settings and a collider to the virtual object.

For example, a Physion Groom component is added to a virtual object (an Actor) in the Unreal Engine, and several Physion Sdf components that are responsible for colliding with and driving a movement of a hair root special effect particle on virtual hair are mounted in the Physion Groom component. The Physion Sdf component may select a plurality of analytic collider forms, such as a capsule body, a sphere, and a plane.

In some embodiments, a detail panel of each Physion component is added under the Actor, showing a hierarchical relationship between Physion components.

For example, the Physion Groom component provides some basic physical settings of the Physion, such as a gravity direction and a grid density, which generally do not need to be modified by the user.

For example, the Physion Sdf component is a collider component, configured to process hair binding and collision. The Physion Sdf component includes a plurality of shapes, such as a capsule body and a sphere.

For example, a Physion Sub Groom component is configured to mount a component of virtual hair parameters. Currently, most parameters of virtual hair are modified under the component.

Operation 1230: Add several blocks of virtual hair.

For example, several Physion Sub Groom components are mounted on the Physion Sdf component that drives the movement of the hair root special effect particle on the virtual hair. The Physion Sub Groom component is mainly responsible for mounting a Groom asset corresponding to a “hair block” and taking a generating responsibility.

Operation 1240: Set a hair parameter and align the virtual hair with the collider.

For example, setting the parameter of the virtual hair is: mounting different “hair blocks” respectively to different Physion Sub Groom components, and after mounting, the virtual hair and the collider (for example, a capsule body) shown by the Physion Sdf are aligned.

In some embodiments, as shown in FIG. 13, an area 1310 is an actual scene in which the Physion Groom plug-ins are set in the Unreal Engine. In other words, the area 1310 shows a scene after a corresponding hair asset is mounted for the Physion Sub Groom and aligned with the Physion Sdf. A setting process is represented by using an area shown in an area 1320 in FIG. 13.

Operation 1250: Adjust a physical parameter and preview simulation.

For example, a real-time simulation result can be previewed by adjusting various physical parameters on a Physics Sub Groom component, and then clicking for playing in an Unreal Engine editor.

FIG. 14 shows an application example on a product side of mounting a plurality of complex hair blocks by using a Physion Groom plug-in. As shown in an area 1410, virtual hair of a virtual object may be implemented as various hair styles such as long hair 1411, curly hair, and braids 1412. As shown in the area 1420, it can be seen from a detail panel that a plurality of Physion Sub Groom components are placed under a Physion Sdf component. The plurality of Physion Sub Groom components are responsible for a mounting process of each hair block.

The foregoing application scenario and application example are merely an example for illustration. This is not limited in the embodiments of the present disclosure.

In conclusion, a problem of poor analysis efficiency caused by directly performing comprehensive analysis on a plurality of polylines is avoided. The plurality of polylines are first respectively analyzed, the speed change amounts respectively corresponding to the plurality of special effect particles on the polylines are determined, and the plurality of polylines are further comprehensively analyzed based on analyzing the plurality of polylines respectively. In this way, calculation and analysis efficiency can be improved, an animation of a strip-shaped three-dimensional model moving with a specified three-dimensional model can be generated more instantaneously and efficiently, and timeliness of animation generation can be improved, so that the animation generation method for a strip-shaped three-dimensional model can be applied to a wider range of scenarios.

In the embodiments of the present disclosure, a frame for rapidly and stably simulating a hair animation is provided. A DER algorithm and an MPM algorithm are combined, and a large number of engineering practice policies are provided to ensure high efficiency and high stability. Therefore, the algorithm frame obtained through combining the DER algorithm and the MPM algorithm can produce a hair animation with a high sense of reality within a limited time budget. The algorithm framework can be applied to various real-time scenes to generate high-quality virtual hair and improve simulation of virtual objects.

FIG. 15 is a structural block diagram of an animation generation apparatus according to an exemplary embodiment of the present disclosure. As shown in FIG. 15, the apparatus includes the following parts:
a polyline determining module 1510, configured to determine polylines respectively corresponding to a plurality of strip-shaped three-dimensional models, where the polyline includes a plurality of special effect particles, and the strip-shaped three-dimensional model is bound to a specified three-dimensional model;
a force determining module 1520, configured to determine, for a target polyline in the plurality of polylines, in response to that the specified three-dimensional model moves at an i^{th} moment, force data respectively corresponding to the plurality of special effect particles on the target polyline at the i^{th} moment based on a movement speed and a movement direction of the specified three-dimensional model, where the force data is configured for indicating a force status of the special effect particle on the target polyline when moving with the specified three-dimensional model, and i is a positive integer;
a speed determining module 1530, configured to calculate a speed change amount of each special effect particle on the target polyline from the i^{th} moment to an (i+1)^{th} moment based on the force data corresponding to the special effect particle; and
a trajectory calculation module 1540, configured to calculate movement trajectories respectively corresponding to the special effect particles on the plurality of polylines based on movement speeds of the special effect particles on the plurality of polylines at the i^{th} moment and speed change amounts of the special effect particles on the plurality of polylines from the i^{th} moment to the (i+1)^{th} moment, and generate, based on the movement trajectories, an animation of the strip-shaped three-dimensional models moving with the specified three-dimensional model.

In an exemplary embodiment, the trajectory calculation module 1540 is configured to:
fuse a speed change amount of a target special effect particle from the i^{th} moment to the (i+1)^{th} moment with a movement speed of the target special effect particle at the i^{th} moment, to obtain a first adjusted speed of the target special effect particle, where the first adjusted speed is configured for representing a movement status of the target special effect particle at a sub-moment between the i^{th} moment and the (i+1)^{th} moment; obtain first adjusted speeds respectively corresponding to a plurality of special effect particles on the plurality of polylines; and determine movement trajectories respectively corresponding to the special effect particles on the plurality of polylines based on a plurality of first adjusted speeds of the special effect particles on the plurality of polylines within a preset time period, where the preset time period includes a plurality of moments including the i^{th} moment.

In an exemplary embodiment, the plurality of polylines are located in a special effect grid space, and the special effect particles on the plurality of polylines are located in the special effect grid space; and
the trajectory calculation module 1540 is configured to:
bind first adjusted speeds respectively corresponding to the plurality of special effect particles to the corresponding special effect particles, to obtain a plurality of binding results; and map the plurality of binding results to the special effect grid space for particle collision detection, to obtain movement trajectories corresponding to the special effect particles within the preset time period.

In an exemplary embodiment, the trajectory calculation module 1540 is configured to:
map the plurality of binding results to the special effect grid space; perform collision simulation on the plurality of binding results by using the special effect grid space, to obtain second adjusted speeds respectively corresponding to the plurality of special effect particles; and map a second adjusted speed corresponding to the special effect particle in the plurality of second adjusted speeds to the special effect particle, to obtain a movement trajectory corresponding to the special effect particle within the preset time period.

In an exemplary embodiment, the speed determining module 1530 is configured to:
determine a first speed of the special effect particle corresponding to the force data at the i^{th} moment; determine an acceleration of the special effect particle at the i^{th} moment based on the force data; calculate a second speed of the special effect particle at the (i+1)^{th} moment based on the first speed of the special effect particle at the i^{th} moment and the acceleration of the special effect particle at the i^{th} moment; and determine a difference between the second speed and the first speed as the speed change amount of the special effect particle from the i^{th} moment to the (i+1)^{th} moment.

In an exemplary embodiment, the speed determining module 1530 is configured to:
obtain a special effect particle mass of the special effect particle; and determine the acceleration of the special effect particle at the i^{th} moment based on the force data and the special effect particle mass.

In an exemplary embodiment, the force determining module 1520 is configured to:
determine at least one of a stretching force, a bending force, or a twisting force respectively corresponding to the plurality of special effect particles at the i^{th} moment based on the movement speed and the movement direction of the specified three-dimensional model, where the stretching force is configured for indicating stretching of the special effect particle by two adjacent special effect particles, the bending force is configured for indicating a planar impact of the two adjacent special effect particles on the special effect particle, and the twisting force is configured for indicating a spatial impact of the two adjacent special effect particles on the special effect particle; and determine the force data respectively corresponding to the plurality of special effect particles based on the at least one of the stretching force, the bending force, or the twisting force.

In an exemplary embodiment, the force determining module 1520 is configured to:
determine, for any target special effect particle in the plurality of special effect particles, a target stretching force, a target bending force, and a target twisting force corresponding to the target special effect particle; and determine a resultant force of the target stretching force, the target bending force, and the target twisting force as the force data corresponding to the target special effect particle.

In an exemplary embodiment, the force determining module 1520 is configured to:
determine, for any target special effect particle in the plurality of special effect particles, a first special effect particle and a second special effect particle adjacent to the target special effect particle; obtain a first bending energy value corresponding to the first special effect particle and a second bending energy value corresponding to the second special effect particle based on the movement speed and the movement direction of the specified three-dimensional model, where the first bending energy value is configured for representing a change in an angle of a particle connection edge connecting the first special effect particle and the target special effect particle, and the second bending energy value is configured for representing a change in an angle of a particle connection edge connecting the second special effect particle and the target special effect particle; and obtain the bending force of the target special effect particle based on the first bending energy value and the second bending energy value.

In an exemplary embodiment, the force determining module 1520 is configured to:
determine a third special effect particle adjacent to the first special effect particle and the target special effect particle; determine a fourth special effect particle adjacent to the second special effect particle and the target special effect particle; obtain the first bending energy value based on relative positions of the first special effect particle, the third special effect particle, and the target special effect particle; and obtain the second bending energy value based on relative positions of the second special effect particle, the fourth special effect particle, and the target special effect particle.

In an exemplary embodiment, the speed determining module 1530 is further configured to:
obtain speed change amounts respectively corresponding to a plurality of special effect particles on the plurality of polylines based on a parallel analysis of the plurality of polylines.

In an exemplary embodiment, the speed determining module 1530 is configured to:
obtain a first quantity of polylines from the plurality of polylines; obtain speed change amounts respectively corresponding to a plurality of special effect particles on the first quantity of polylines; obtain a second quantity of polylines other than the first quantity of polylines from the plurality of polylines; and perform an interpolation operation based on the speed change amounts respectively corresponding to the plurality of special effect particles on the first quantity of polylines, to obtain interpolated speed change amounts respectively corresponding to the second quantity of polylines as the speed change amounts respectively corresponding to the plurality of special effect particles on the second quantity of polylines.

In an exemplary embodiment, the trajectory calculation module 1540 is configured to:
generate a plurality of movement trajectory animation frames based on the movement trajectories respectively corresponding to the plurality of special effect particles; and generate the animation based on the plurality of movement trajectory animation frames.

In conclusion, a problem of poor analysis efficiency caused by directly performing comprehensive analysis on a plurality of polylines is avoided. The plurality of polylines are first respectively analyzed, the speed change amounts respectively corresponding to the plurality of special effect particles on a single polyline are determined, and the plurality of polylines are further comprehensively analyzed based on analyzing the plurality of polylines respectively. In this way, calculation and analysis efficiency can be improved while ensuring trajectory calculation accuracy, an animation of a strip-shaped three-dimensional model moving with a specified three-dimensional model can be generated more instantaneously and efficiently, and timeliness of animation generation can be improved, so that the animation generation method for a strip-shaped three-dimensional model can be applied to a wider range of scenarios.

The animation generation apparatus provided in the foregoing embodiments is only illustrated by taking the division of the foregoing functional modules as an example. In an actual application, the foregoing functions may be allocated to and completed by different functional modules according to requirements. In other words, an internal structure of a device is divided into different functional modules, to complete all or some of the functions described above. In addition, the animation generation apparatus and animation generation method embodiments provided in the foregoing embodiments belong to the same conception. For an implementation process, reference may be made to the method embodiments, and details are not described herein again.

FIG. 16 is a schematic structural diagram of a server according to an exemplary embodiment of the present disclosure. The server 1600 includes a central processing unit (CPU) 1601, a system memory 1604 including a random access memory (RAM) 1602 and a read-only memory (ROM) 1603, and a system bus 1605 connecting the system memory 1604 to the central processing unit 1601. The server 1600 further includes a mass storage device 1606 configured to store an operating system 1613, an application 1614, and another program module 1615.

The mass storage device 1606 is connected to the central processing unit 1601 by using a mass storage controller (not shown) that is connected to the system bus 1605. The mass storage device 1606 and a computer-readable medium associated with the mass storage device 1606 provide non-volatile storage for the server 1600. In other words, the mass storage device 1606 may include a computer-readable medium (not shown) such as a hard disk or a compact disc read-only memory (CD-ROM) drive.

In general, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The system memory 1604 and the mass storage device 1606 mentioned above may be collectively referred to as a memory.

According to the embodiments of the present disclosure, the server 1600 may further be connected, through a network such as the Internet, to a remote computer on the network and run. To be specific, the server 1600 may be connected to a network 1612 by using a network interface unit 1611 that is connected to the system bus 1605, or may be connected to a network of another type or a remote computer system (not shown) by using the network interface unit 1611.

The foregoing memory further includes one or more programs. The one or more programs are stored in the memory and are configured to be executed by the CPU.

An embodiment of the present disclosure further provides a computer device. The computer device includes a processor and a memory. The memory has at least one instruction, at least one segment of program, and a code set or an instruction set stored therein. The at least one instruction, the at least one segment of program, and the code set or the instruction set are loaded and executed by the processor to implement the animation generation method provided in the foregoing method embodiments.

An embodiment of the present disclosure further provides a computer-readable storage medium. The computer-readable storage medium has at least one instruction, at least one segment of program, and a code set or an instruction set stored therein. The at least one instruction, the at least one segment of program, and the code set or the instruction set are loaded and executed by a processor to implement the animation generation method provided in the foregoing method embodiments.

The embodiments of the present disclosure further provide a computer program product or a computer program. The computer program product or the computer program includes computer instructions, and the computer instructions are stored in a computer-readable storage medium. A processor of a computer device reads the computer instructions from the computer-readable storage medium. The processor executes the computer instructions, to cause the computer device to perform the animation generation method according to any one of the foregoing embodiments.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. An animation generation method, performed by a computing device, comprising:
determining a plurality of polylines respectively corresponding to a plurality of strip-shaped three-dimensional models, wherein each of the plurality of polylines comprises a plurality of special effect particles, and each of the plurality of strip-shaped three-dimensional models is bound to a specified three-dimensional model;
for a target polyline in the plurality of polylines, determining, in response to the specified three-dimensional model moving at an i^{th} moment, force data respectively corresponding to the plurality of special effect particles on the target polyline at the i^{th} moment based on a movement speed and a movement direction of the specified three-dimensional model, wherein the force data is configured to indicate a force status of each of the plurality of special effect particles on the target polyline while moving with the specified three-dimensional model, and wherein i is a positive integer;
calculating a speed change amount of each of the plurality of special effect particles on the target polyline from the i^{th} moment to an (i+1)^{th} moment based on the force data corresponding to the special effect particle;
calculating movement trajectories respectively corresponding to the plurality of special effect particles on the plurality of polylines based on movement speeds of the plurality of special effect particles on the plurality of polylines at the i^{th} moment and speed change amounts of the plurality of special effect particles on the plurality of polylines from the i^{th} moment to the (i+1)^{th} moment; and
generating, based on the movement trajectories, an animation of the plurality of strip-shaped three-dimensional models moving with the specified three-dimensional model.

2. The method according to claim 1, wherein the calculating the movement trajectories respectively corresponding to the plurality of special effect particles on the plurality of polylines based on the movement speeds of the plurality of special effect particles on the plurality of polylines at the i^{th} moment and the speed change amounts of the plurality of special effect particles on the plurality of polylines from the i^{th} moment to the (i+1)^{th} moment comprises:
fusing a speed change amount of a target special effect particle from the i^{th} moment to the (i+1)^{th} moment with a movement speed of the target special effect particle at the i^{th} moment, to obtain a first adjusted speed of the target special effect particle, wherein the first adjusted speed is configured to represent a movement status of the target special effect particle at a sub-moment between the i^{th} moment and the (i+1)^{th} moment;
obtaining first adjusted speeds respectively corresponding to the plurality of special effect particles on the plurality of polylines; and
determining movement trajectories respectively corresponding to the plurality of special effect particles on the plurality of polylines based on a plurality of first adjusted speeds of the plurality of special effect particles on the plurality of polylines within a preset time period, wherein the preset time period comprises a plurality of moments comprising the i^{th} moment.

3. The method according to claim 2, wherein the plurality of polylines are located in a special effect grid space, and the plurality of special effect particles on the plurality of polylines are located in the special effect grid space; and
wherein the determining the movement trajectories respectively corresponding to the plurality of special effect particles on the plurality of polylines based on the plurality of first adjusted speeds of the plurality of special effect particles on the plurality of polylines within the preset time period comprises:
binding first adjusted speeds respectively corresponding to a plurality of special effect particles to the corresponding special effect particles, to obtain a plurality of binding results; and
mapping the plurality of binding results to the special effect grid space for particle collision detection, to obtain the movement trajectories corresponding to the plurality of special effect particles within the preset time period.

4. The method according to claim 3, wherein the mapping the plurality of binding results to the special effect grid space for particle collision detection, to obtain the movement trajectories corresponding to the plurality of special effect particles within the preset time period comprises:
mapping the plurality of binding results to the special effect grid space;
performing collision simulation on the plurality of binding results by using the special effect grid space, to obtain a plurality of second adjusted speeds respectively corresponding to the plurality of special effect particles; and
mapping a second adjusted speed corresponding to a special effect particle in the plurality of second adjusted speeds to the special effect particle, to obtain a movement trajectory corresponding to the special effect particle within the preset time period.

5. The method according to claim 1, wherein the calculating the speed change amount of each of the plurality of special effect particles from the i^{th} moment to the (i+1)^{th} moment based on the force data corresponding to the special effect particle comprises:
determining a first speed of the special effect particle corresponding to the force data at the i^{th} moment;
determining an acceleration of the special effect particle at the i^{th} moment based on the force data;
calculating a second speed of the special effect particle at the (i+1)^{th} moment based on the first speed of the special effect particle at the i^{th} moment and the acceleration of the special effect particle at the i^{th} moment; and
determining a difference between the second speed and the first speed as the speed change amount of the special effect particle from the i^{th} moment to the (i+1)^{th} moment.

6. The method according to claim 5, wherein the determining the acceleration of the special effect particle at the i^{th} moment based on the force data comprises:
obtaining a special effect particle mass of the special effect particle; and
determining the acceleration of the special effect particle at the i^{th} moment based on the force data and the special effect particle mass.

7. The method according to claim 1, wherein the determining, the force data respectively corresponding to the plurality of special effect particles on the target polyline at the i^{th} moment based on the movement speed and the movement direction of the specified three-dimensional model comprises:
determining at least one of a stretching force, a bending force, or a twisting force respectively corresponding to the plurality of special effect particles at the i^{th} moment based on the movement speed and the movement direction of the specified three-dimensional model, wherein the stretching force is configured to indicate stretching of one of the plurality of special effect particles by two adjacent special effect particles, the bending force is configured to indicate a planar impact of the two adjacent special effect particles on the special effect particle, and the twisting force is configured to indicate a spatial impact of the two adjacent special effect particles on the special effect particle; and
determining the force data respectively corresponding to the plurality of special effect particles based on the at least one of the stretching force, the bending force, or the twisting force.

8. The method according to claim 7, wherein the determining the force data respectively corresponding to the plurality of special effect particles based on the at least one of the stretching force, the bending force, or the twisting force comprises:
determining, for a target special effect particle in the plurality of special effect particles, a target stretching force, a target bending force, and a target twisting force corresponding to the target special effect particle; and
determining a resultant force of the target stretching force, the target bending force, and the target twisting force as the force data corresponding to the target special effect particle.

9. The method according to claim 7, wherein the bending force is determined in the following manner:
determining, for a target special effect particle in the plurality of special effect particles, a first special effect particle and a second special effect particle adjacent to the target special effect particle;
obtaining a first bending energy value corresponding to the first special effect particle and a second bending energy value corresponding to the second special effect particle based on the movement speed and the movement direction of the specified three-dimensional model, wherein the first bending energy value is configured to represent a change in an angle of a particle connection edge connecting the first special effect particle and the target special effect particle, and wherein the second bending energy value is configured to represent a change in an angle of a particle connection edge connecting the second special effect particle and the target special effect particle; and
obtaining the bending force of the target special effect particle based on the first bending energy value and the second bending energy value.

10. The method according to claim 9, wherein the obtaining the first bending energy value corresponding to the first special effect particle and the second bending energy value corresponding to the second special effect particle comprises:
determining a third special effect particle adjacent to the first special effect particle and a target special effect particle in the plurality of special effect particles;
determining a fourth special effect particle adjacent to the second special effect particle and the target special effect particle;
obtaining the first bending energy value based on relative positions of the first special effect particle, the third special effect particle, and the target special effect particle; and
obtaining the second bending energy value based on relative positions of the second special effect particle, the fourth special effect particle, and the target special effect particle.

11. The method according to claim 1, further comprising:
obtaining speed change amounts respectively corresponding to one or more of the plurality of special effect particles on the plurality of polylines based on a parallel analysis of the plurality of polylines.

12. The method according to claim 11, wherein the obtaining the speed change amounts respectively corresponding to the one or more of the plurality of special effect particles on the plurality of polylines based on the parallel analysis of the plurality of polylines comprises:
obtaining a first quantity of polylines from the plurality of polylines;
obtaining speed change amounts respectively corresponding to the one or more of the plurality of special effect particles on the first quantity of polylines;
obtaining a second quantity of polylines other than the first quantity of polylines from the plurality of polylines; and
performing an interpolation operation based on the speed change amounts respectively corresponding to the one or more of the plurality of special effect particles on the first quantity of polylines, to obtain interpolated speed change amounts respectively corresponding to the second quantity of polylines as the speed change amounts respectively corresponding to the one or more of the plurality of special effect particles on the second quantity of polylines.

13. The method according to claim 1, wherein the generating, based on the movement trajectories, the animation of the plurality of strip-shaped three-dimensional models moving with the specified three-dimensional model comprises:
generating a plurality of movement trajectory animation frames based on the movement trajectories respectively corresponding to the plurality of special effect particles; and
generating the animation based on the plurality of movement trajectory animation frames.

14. A computing device, comprising:
one or more processors; and
memory storing instructions that, when executed by the one or more processors, cause the computing device to facilitate:
determining a plurality of polylines respectively corresponding to a plurality of strip-shaped three-dimensional models, wherein each of the plurality of polylines comprises a plurality of special effect particles, and each of the plurality of strip-shaped three-dimensional models is bound to a specified three-dimensional model;
for a target polyline in the plurality of polylines, determining, in response to the specified three-dimensional model moving at an i^{th} moment, force data respectively corresponding to the plurality of special effect particles on the target polyline at the i^{th} moment based on a movement speed and a movement direction of the specified three-dimensional model, wherein the force data is configured to indicate a force status of each of the plurality of special effect particles on the target polyline while moving with the specified three-dimensional model, and wherein i is a positive integer;
calculating a speed change amount of each of the plurality of special effect particles on the target polyline from the i^{th} moment to an (i+1)^{th} moment based on the force data corresponding to the special effect particle;
calculating movement trajectories respectively corresponding to the plurality of special effect particles on the plurality of polylines based on movement speeds of the plurality of special effect particles on the plurality of polylines at the i^{th} moment and speed change amounts of the plurality of special effect particles on the plurality of polylines from the i^{th} moment to the (i+1)^{th} moment; and
generating, based on the movement trajectories, an animation of the plurality of strip-shaped three-dimensional models moving with the specified three-dimensional model.

15. The computing device according to claim 14, wherein the instructions, when executed by the one or more processors, cause the computing device to facilitate:
fusing a speed change amount of a target special effect particle from the i^{th} moment to the (i+1)^{th} moment with a movement speed of the target special effect particle at the i^{th} moment, to obtain a first adjusted speed of the target special effect particle, wherein the first adjusted speed is configured to represent a movement status of the target special effect particle at a sub-moment between the i^{th} moment and the (i+1)^{th} moment;
obtaining first adjusted speeds respectively corresponding to the plurality of special effect particles on the plurality of polylines; and
determining movement trajectories respectively corresponding to the plurality of special effect particles on the plurality of polylines based on a plurality of first adjusted speeds of the plurality of special effect particles on the plurality of polylines within a preset time period, wherein the preset time period comprises a plurality of moments comprising the i^{th} moment.

16. The computing device according to claim 15, wherein the plurality of polylines are located in a special effect grid space, and the plurality of special effect particles on the plurality of polylines are located in the special effect grid space; and
wherein the instructions, when executed by the one or more processors, cause the computing device to facilitate:
binding first adjusted speeds respectively corresponding to a plurality of special effect particles to the corresponding special effect particles, to obtain a plurality of binding results; and
mapping the plurality of binding results to the special effect grid space for particle collision detection, to obtain the movement trajectories corresponding to the plurality of special effect particles within the preset time period.

17. The computing device according to claim 16, wherein the instructions, when executed by the one or more processors, cause the computing device to facilitate:
mapping the plurality of binding results to the special effect grid space;
performing collision simulation on the plurality of binding results by using the special effect grid space, to obtain a plurality of second adjusted speeds respectively corresponding to the plurality of special effect particles; and
mapping a second adjusted speed corresponding to a special effect particle in the plurality of second adjusted speeds to the special effect particle, to obtain a movement trajectory corresponding to the special effect particle within the preset time period.

18. The computing device according to claim 14, wherein the instructions, when executed by the one or more processors, cause the computing device to facilitate:
determining a first speed of the special effect particle corresponding to the force data at the i^{th} moment;
determining an acceleration of the special effect particle at the i^{th} moment based on the force data;
calculating a second speed of the special effect particle at the (i+1)^{th} moment based on the first speed of the special effect particle at the i^{th} moment and the acceleration of the special effect particle at the i^{th} moment; and
determining a difference between the second speed and the first speed as the speed change amount of the special effect particle from the i^{th} moment to the (i+1)^{th} moment.

19. The computing device according to claim 18, wherein the instructions, when executed by the one or more processors, cause the computing device to facilitate:
obtaining a special effect particle mass of the special effect particle; and
determining the acceleration of the special effect particle at the i^{th} moment based on the force data and the special effect particle mass.

20. A non-transitory computer-readable medium, having computer-executable instructions stored thereon, when executed by one or more processors of a computing device, cause the computing device to facilitate:
determining a plurality of polylines respectively corresponding to a plurality of strip-shaped three-dimensional models, wherein each of the plurality of polylines comprises a plurality of special effect particles, and each of the plurality of strip-shaped three-dimensional models is bound to a specified three-dimensional model;
for a target polyline in the plurality of polylines, determining, in response to the specified three-dimensional model moving at an i^{th} moment, force data respectively corresponding to the plurality of special effect particles on the target polyline at the i^{th} moment based on a movement speed and a movement direction of the specified three-dimensional model, wherein the force data is configured to indicate a force status of each of the plurality of special effect particles on the target polyline while moving with the specified three-dimensional model, and wherein i is a positive integer;
calculating a speed change amount of each of the plurality of special effect particles on the target polyline from the i^{th} moment to an (i+1)^{th} moment based on the force data corresponding to the special effect particle;
calculating movement trajectories respectively corresponding to the plurality of special effect particles on the plurality of polylines based on movement speeds of the plurality of special effect particles on the plurality of polylines at the i^{th} moment and speed change amounts of the plurality of special effect particles on the plurality of polylines from the i^{th} moment to the (i+1)^{th} moment; and
generating, based on the movement trajectories, an animation of the plurality of strip-shaped three-dimensional models moving with the specified three-dimensional model.
